(19) United States
(12) Patent Application Publication
(10) Pub. No.: US 2023/0080799 A1
(43) Pub. Date: Mar. 16, 2023

(54) In-Cinema And/Or Online Edutainment System

(71) Applicant: Leanne Frisbie, Valley Village, CA (US)

(72) Inventors: Leanne Frisbie, Valley Village, CA (US); Barrie Osborne, Mill Valley, CA (US); Fleur Saville, Los Angeles, CA (US); Jan Sosinko, Mangawhai Heads (NZ); Antonia Prebble, Mt. Albert (NZ)

(21) Appl. No.: 17/476,713

(22) Filed: Sep. 16, 2021

(51) Int. Cl. G09B 5/06; G09B 5/12; A63F 13/47; A63F 13/67; G02B 27/01; G06T 19/00

(52) U.S. Cl. CPC G09B 5/067; G09B 5/125; A63F 13/47; A63F 13/67; G02B 27/017; G06T 19/006

(57) ABSTRACT

A computerized educational and entertainment system for one or more users comprising several modules, including a film module and an educational game module, wherein audio-video content of the film module is interrupted by one or more active modes at one or more set times to provide interactive teaching of subject matter.

### CROSS-REFERENCE TO RELATED APPLICATIONS

This application claims the benefit of U.S. Provisional Patent Application 62/693,328 filed on Jul. 2, 2018, the contents of which are hereby incorporated by reference in in its entirety.

### FIELD OF THE INVENTION

This invention relates to the field of edutainment, specifically to the use of technology in the learning process in order to stimulate higher cognitive learning in at least one user.

### BACKGROUND OF THE INVENTION

Currently, feature films and gaming are offered as separate experiences. While some games make an attempt at a narrative within the game, there is not yet a film that offers a gaming experience as part of its narrative.

A passive film has the capacity to generate heightened states of emotion and energy, including feelings of motivation, inspiration and passion, but because of the passive nature of the film, viewers do not have an outlet for the energy generated by their viewing experience. So, effectively, the energy of the experience is not used and thus can be wasted.

Recent films that have employed MR (mixed reality) technology to make films more dynamic are set in a mode where the viewer is able to have control over the narrative. This control means that the viewer may have an active relationship with the film, but the storyteller loses their ability to take the viewer on a journey because the viewer effectively takes on the role of director. The subsequent loss of control over the story is off-putting to many film directors and is thwarting the introduction of MR cinema as a mainstream film experience.

While gaming is a hugely popular entertainment medium that is continually growing in popularity, education in its current form is generally perceived as boring because of the unimaginative way that the topics are taught.

The Pythagoreans and other Mystery Schools of the past integrated all elements of life: home-life, leisure, education, work and entertainment were all considered to be one. The main aim of life was to ‘know thyself’.

As Laurence Pearsall Jacks said, “A master in the art of living draws no sharp distinction between his work and his play; his labor and his leisure; his mind and his body; his education and his recreation. He hardly knows which is which. He simply pursues his vision of excellence through whatever he is doing, and leaves others to determine whether he is working or playing. To himself, he always appears to be doing both.”

This integration is the ideal mode by which to live. However, in modern society, we do the opposite. We have separated work from personal development and education from entertainment. This separation is our downfall. It means that we are operating at far less than our true capacity and, therefore, we will never reach our potential for self-actualization and transcendence.

We are at our best when different aspects of our lives and being are integrated; when we are operating at the height of ourselves. When our brains are stimulated in a fun, nurturing manner is when we begin to tap into what we are truly capable of. The entertainment industry today does not exploit this truth of our humanity. Instead, billions of dollars have been spent on creating isolating and passive experiences for the purposes of escapist entertainment only.

It would be highly beneficial to the development and evolution of humanity to change the intention and substance of our in-cinema experience to one that seamlessly combines entertainment and education and, as such, reveals the truth that learning is, and should always be, a joyful process. Improved educational experiences, apparatus and methods are thus needed. Such improvements would better channel the student's energy and senses into the active learning of an educational topic (e.g., learning a musical instrument). Such improvements would use the popular medium of gaming and the heightened states of emotion and energy of cinema without compromising the film's narrative in novel and non-obvious inventions.

### SUMMARY OF THE INVENTION

This invention is capable of providing an interactive film system for stimulating higher cognitive processes of one or more users, bridging gaps between education, gaming and cinema. The energy and heightened senses generated by viewing a film are channeled into the active learning of an educational topic (such as learning a musical instrument) through the hugely popular medium of gaming, without compromising the film's narrative, as prescribed by its creators. Through the integration of film, gaming and education, the brain is highly stimulated and enables the user to tap into what they are truly capable of. Preferred embodiments of this invention combine the teaching of a musical instrument or any other educational topic with full immersion in a film narrative. These preferred embodiments provide an interactive experience that is situated in a cinema or any other room or location for either one or multiple users.

It is the object of certain embodiments of this invention to teach all essential skills including, plumbing, construction, life skills, dentistry, farming and educational subjects such as medical science, math, law, embedded in a cinematic film and/or TV Series narrative of different genres such as drama, sci-fi, fantasy, thriller, documentaries, which creates the tone and atmosphere of the educational game segment.

It is an object of certain embodiments of this invention to provide an improved method of teaching and/or learning by immersing lessons in a cinematic movie-like experience or any film experience including TV Series, online streaming.

It is an object of certain embodiments of this invention to provide an improved method of teaching and/or learning by using interactive video or computer gaming-like experiences as lessons.

It is an object of certain embodiments of this invention to provide an improved method of teaching and/or learning by immersing interactive video or computer gaming-like experiences as lessons in a cinematic movie-like experience or any film experience including TV Series, online streaming.

It is an object of certain embodiments of this invention to provide an improved method of teaching and/or learning by immersing interactive video or computer gaming-like experiences as lessons in a cinematic movie-like experience, or any film experience including TV Series, online streaming, wherein the gaming-like experience is adjusted to the user's ability.

It is an object of certain embodiments of this invention to provide an improved method of teaching and/or learning by immersing interactive video or computer gaming-like experiences as lessons in a cinematic movie-like experience or any film experience including TV Series, online streaming, wherein the gaming-like experience is incorporated within the cinematic movie-like experience seamlessly.

These and other objects of the invention are provided by its various embodiments. Through the present invention, the modality of conventional film watching may be changed to one that incorporates both a passive film and an educational game. The film may capitalize on the open, heightened state that passive viewing creates and then focus that energy into the user/s' learning a new task/subject/topic. This two-step process means that the words “Education” and “Entertainment” can become synonymous.

During the educational game segment of certain embodiments, users participate in the learning of music and/or any other educational topic and/or skill and/or knowledge in any subject, or they can choose to engage with predetermined, alternative tasks that are presented as options within the game, or they can explore the world of the film's narrative.

The systems and methods of certain embodiments of this invention relate to the user playing an educational game that has been inserted intermittently into a any film experience including a feature film, TV Series, online streaming film, as part of the narrative. The VR (virtual reality) or AR (augmented reality) or MR (mixed reality) educational game adjusts its difficulty level according to the user's ability via a feedback mechanism that picks up on the user's ability as they play the game. In certain embodiments, the game also gives the user encouraging feedback as they play and provides them with stretch goals to improve their ability if they are playing the game competently. Conversely, if the user is struggling with the game at the current level, the feedback mechanism in certain embodiments will recognize this and adjust the level to make the game easier, and it provides encouraging feedback and suggestions to the user. The user is also able to opt out of the learning segment and explore the world of the film during the gaming sequences in the film.

In certain preferred embodiments, at the end of each preset gaming segment, the film narrative resumes through seamlessly switching the user from the individualized gaming experience to a film experience on an actual screen either on a home TV or computer screen or mobile device or on a large cinema screen located in a cinema or similar public viewing space. The switching between the films and gaming experience is not able to be determined by the user but is preprogrammed so that the game is part of the film's narrative and the narrative cannot be dictated by the audience. At the end of the film/game experience, the user has been taught a topic to a certain level. For example, if the film/game experience is teaching music, the user has been taught one or more grades of music theory and practice through watching the film and playing the game that has been inserted into the film's narrative. The educational game is consistent in look and feel to the themes of the film's narrative, and characters and places in the film are mirrored in the game so that the user feels as if they are in the film's narrative when they are playing the game. They can also interact with characters and places that have been featured in the film as part of their learning experience in the game. The switch between the game and the film is made possible in preferred embodiments through a headmount and other output devices, which enables a seamless transition—barely noticeable by the user—between an individualized gaming experience and a film viewing experience. In these embodiments, the system includes a timeline software and/or program and/or function and/or system that automatically switches the lenses in the headmount from an individual gaming screen into see-through lenses for watching the film segments on a separate screen and back again.

A preferred group of embodiments of this invention is known as the Mastertude Film/System. These preferred embodiments reside on one or more servers and communicate over a wireless network to incorporate elements of a passive mode with a first active mode (e.g., where user/s engage with a shared story) and a second active mode (e.g., where user/s are experiencing an isolated story). This structure is governed by a central system, and related software, which switches between at least these three modes, according to a predetermined timeline. For the passive mode, all user/s watch the story in a passive way and do not interact with the film at all. For the shared educational game, the user/s can assert a certain amount of control, however the film narrative remains one that is shared and predetermined. For the isolated educational game, the user/s have what they perceive as complete, subjective control over their reality for a predetermined allotment of time, as determined by the timeline.

In certain preferred embodiments of the Mastertude Film/System, the user is switched between the interactive educational game modes and the passive mode automatically and the modality goes from a VR game that is viewed in the VR headmount, to watching the 2D/3D film on a separate screen. The switch from VR to 3D/2D viewing occurs through lenses located in the headmount, which are able to automatically convert from a VR screen to see-through lenses with or without 3D viewing capability.

In particularly preferred embodiments, the visual mechanism on the lenses and/or glasses and/or screens and/or panels of the headmount are fitted with sensors and/or send/receive a digital signal from the computerized system and/or timeline and/or server to switch into one of four modes (e.g., a passive mode, a first active mode, a second active mode, a combination mode) and/or switch from see-through to opaque and/or open and shut a visor and/or shutter screen.

In certain preferred embodiments of the Mastertude Film/System, during the educational game segment, the user is able to sing along with the music that is playing through a microphone device that is installed in the headmount. Once the educational game segment is over and the film has switched into passive mode, the film's narrative continues and the user/s has no control over the narrative segments.

In certain preferred embodiments of the Mastertude Film/System, the film narrative is about a mysterious order that teaches music theory and practices through an accelerated music learning system. The film is presented in 3D/2D and the game is presented as a VR/AR or MR educational game, which teaches the music system taught by the order.

In certain preferred embodiments of the Mastertude Film/System, the educational gaming part of the film includes a virtual digital musical keyboard that is seen through a VR headmount and played by the user. In this embodiment, sensors pick up how the user is playing the keyboard and provide feedback to the gaming/teaching software/module and adjust the music learning levels accordingly. In this embodiment, for the participants who have chosen to participate in the VR learning experience, there is an assessment module that monitors their progress. This works in tandem with the teaching module, which teaches them at their particular pace and gives them feedback and suggestions based on their learning needs. For example, if the user/s are learning music, the assessment module monitors their pitch, rhythm, speed and flow, based on predetermined parameters (as in FIG. 2). The user/s receive audio, visual and/or tactile feedback based on their progress.

In this embodiment, the game is contained in a separate piece of software, which is inserted into the film's timeline at preset intervals (and the film narrative is paused during these times). The game is delivered to the user through a headmount, which is equipped to play the software.

In other embodiments of the present invention, the VR/AR/MR gaming headmount is replaced by actual musical instruments, midi devices or other hardware devices, such as gaming consoles or gaming hardware, or mobile devices, which are capable of communicating with or incorporating the teaching and assessment software. The system can be situated in a cinema, theatre, public venue or home studio environment or on a mobile device or personal computer and caters to single and/or multiple users.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a flow diagram that illustrates embodiments of a computerized edutainment system/s and/or servers/s within a cinema or any room that switches between a film narrative and interactive mode for stimulating higher cognitive processes for one or more user/s.

FIG. 2 is a flowchart that illustrates embodiments of a teaching and assessment system, which allows the user/s to interact during an active mode.

FIG. 3 is a flowchart that illustrates embodiments of elements of sending VR and/or AR and/or MR data to AR and/or VR and/or MR output devices, providing an interactive cinema experience.

FIG. 4 is a conceptual flow diagram that illustrates embodiments of an assessment module, which assesses VR and/or AR data, creating an individualized experience for each user/s within a cinema or any room.

FIG. 5 is a block diagram that illustrates embodiments of an edutainment system within a cinema or any room, which delivers immersive content to multiple user/s and switches between a predetermined narrative and interactive VR and/or AR and/or MR experience.

FIG. 6 is a conceptual diagram that illustrates embodiments of a predetermined timeline that sends data signals to a relevant server/s or system/s and maintains the time progression of the cinema experience.

FIG. 7 is a flow diagram that illustrates embodiments of an online individual login into the exemplary Mastertude system/s or server/s.

### DETAILED DESCRIPTION OF THE INVENTION

A computerized educational and entertainment system for one or more users is provided. The system comprises a computerized system and/or server(s) and several modules with several computer executable functions, including a film module and an educational game module, wherein audio-video content of the film module is interrupted by one or more active modes at one or more set times to provide interactive teaching of subject matter. Each of the users can provide input, feedback, instructions, interactions and/or results to the system.

In preferred embodiments, the educational and entertainment (e.g., “edutainment”) system can be configured to provide one or more particular components (e.g., modules, databases, interfaces, devices) and have one or more particular computer executable functions. In these preferred embodiments, components include some or all of a computerized system/s and/or server/s, film modules, teaching interfaces, predetermined timelines (managing and/or operating modes such as a passive mode, first active mode, second active mode and combination mode), assessment modules, assessment compilation modules, educational game modules, teaching modules, personalized modules, submodules, assessment databases, output devices, cinema/real environment devices, and/or additional hardware to access a wired or wireless communication network. However, the module/s and/or database/s and/or interface/s and/or devices can be integrated or further separated into additional modules and/or databases and/or interface/s and/or devices and/or take any other form that allows them to communicate with each other and perform the function/s required. In this regard, server/s and/or component/s and/or console/s and/or any other such elements could be added (or subtracted) and/or changed to perform the function/s desired.

In certain preferred embodiments, each user/s is sent data based on their level of competency. In a group/cinema environment, the user/s are unaware of their category and/or level. In a solo/home environment, the user may or may not be aware of their level and/or category. In certain embodiments, the educational game module, along with the assessment module and assessment compilation module, can change a user's level at any time according to their performance in the most preferred embodiments.

In certain embodiments, in addition to the computerized system/s and/or server/s, there is an additional server/s and/or module/s, which enables a real teacher to have access to assist and/or to change any settings and/or communicate with the user/s either via online chat and/or voice call and/or video call and/or in person and/or hologram within a group environment and/or individual setting. In certain other embodiments, the computerized system/s and/or server/s include a virtual teacher that interacts with the user/s. The virtual teacher can address one or more user/s by name and provide the user/s with instructions and/or guidance and/or encouragement throughout the gaming process.

In preferred embodiments, there are prescribed live and/or prerecorded streaming sessions and/or TV shows on any online platform and/or channel of the film experience and/or a session with a real teacher and/or virtual teacher and/or hologram teacher that one or any number of user/s can participate in either at home or in any other room/s.

In certain embodiments, the user/s can buy and/or have access to various levels of subscription that allows them to access the system and/or the embedded game for the designated duration of the subscription such as, but not limited to, daily, weekly, monthly, annual, lifetime. If the user/s have a current subscription and/or have a login and/or password and/or have access by any other means they can continue playing the game from the level they were at previously

The Computerized System/Servers

The computerized edutainment system/s and/or server/s comprise some or all of one or more processors that each executes computer executable instructions stored in one or more memory devices, a teaching interface, an educational game module, an assessment module, an assessment compilation module and an assessment database and/or other module/s and/or database/s and/or timeline/s and/or component/s and/or console/s as required. The system/s and/or server/s send digital signals to the interface and/or the module/s and/or the database/s and other system/s that may or may not operate in accordance with the timeline/s. The system/s and/or server/s command the output devices, embedded with haptic and/or sonic and/or midi technology and/or sensors and/or other such technology and/or cinema device/s and/or wired or wireless device/s, to activate and deactivate in coordination with the timeline or the functional equivalent of the timeline.

Film Modules

The film modules comprise audio-visual content to stimulate learning by the one or more users. The audio-visual content can provide a cinema or movie-like experience and/or any film-like experience such as a TV Series, Series and movie hybrid, online streaming to the user. In the most preferred embodiments, the audio-visual content can provide a narrative or story in 3D and/or 2D and/or 4D that stimulates the user's interest and/or learning. In certain preferred embodiments, the active modes may or may not have an impact on the film narrative (shown in the passive mode). There is one or more than one film narrative option stored in a film database and, based on the interaction during the active modes, the film module selects an appropriate option if and when required.

In certain embodiments, different versions of audio-visual content may be stored in a film database and/or any other database. Based on the overall feedback received from the output devices of the user/s, the computerized system/s selects a particular version of audio-visual content to be played on the common screen or superimposed on the headmounts of the user/s and/or customizing the group experience and/or the individual/s experience.

Teaching Interfaces

The teaching interfaces comprise interactive interfaces that provide instruction and content data to one or more output devices in the form of i. virtual reality, ii. augmented reality, iii. mixed reality, or iv. a combination of two or more of i. ii., or iii.

The teaching interface (and the educational game module) teaches the user/s music and/or any other educational topic and/or game and/or skill and/or knowledge in any subject. The teaching interface sends audio-visual data and/or VR data and/or MR data and/or AR data to the output device of each user/s. In certain preferred embodiments, the teaching interface and educational game module will keep pace with the user/s' performance and respond accordingly. For example, for these embodiments, the teaching interface may repeat the same subject matter at a slower pace either once or many times, or accelerate the pace, or teach further subject-matter. The system/s operate in this way based on the feedback from the assessment module/s in conjunction with the predetermined timeline/s.

Predetermined Timelines And Modes

One or more predetermined timelines (and functions and/or program and/or software thereof) each provide instructions to an educational game module that determine the length of time given to each of at several modes (e.g., a passive mode, a first active mode, a second active mode, a combination mode).

In certain preferred embodiments, transitions between the different modes (e.g., a passive mode, a first active mode, a second active mode, a combination mode) and a common screen and/or an individualized screen is seamless. Examples of how to make such translations seamless include i. the images duplicate each other, ii. the images play on both screens simultaneously, iii. the images on both screens overlap, iv. the images fade in and out on both screens, v. the images on one screen are replaced by the images on the other screen, vi. one screen is replaced by the other screen, vii. any combination of the above points, and/or viii. any other manner to ensure that the visual and audio content maintain continuity.

In certain preferred embodiments, the timeline software and/or program and/or function and/or system controls and/or sends/receives digital signals to the cinema devices and/or output devices, and/or any device within the cinema, timing every digital signal sent/received to the millisecond, based on the predetermined timeline. In certain preferred embodiments, the timeline software and/or program and/or function and/or system controls and/or sends digital signals online to a separate screen, speaker systems in any room and output devises and/or any device, timing every digital signal sent/received to the millisecond, based on the predetermined timeline.

In certain preferred embodiments, during the operation of the different modes, the visual mechanism on the glasses and/or lenses and/or individual screen and/or panels of the headmount can switch into any one of the four (or less or more) modes as and when needed, according to the timeline/s and/or system/s and/or server/s and/or real teacher. In certain embodiments, the mechanism of the glasses allows the one or many lenses and/or screens and/or panels to operate between: i. see-through 3D glasses, ii. see-through 2D glasses, iii. VR screen and/or glasses, iv. AR screen and/or glasses, and/or v. MR screen and/or glasses. In these and other embodiments, various elements of the physical environment can be controlled by software and/or sensors, and/or physical function and/or digital signals such as lighting and/or shadows and/or sound and/or any other element that affects the sensorial experience of the user/s.

In certain of these embodiments, the visual mechanism on the lenses and/or glasses and/or screens and/or panels of the headmount are fitted with sensors which on receiving a digital signal from the computerized system and/or timeline and/or server switch into one of the four modes and/or switch from see-through to opaque and/or a sensor that will open and shut a visor and/or shutter screen.

In certain of these embodiments, in order for the visual mechanism of the headmount to switch between the operations of the different modes, it is controlled by the computerized system/s and/or server/s and/or manual operation and/or software and/or sensors and/or digital signals that communicate with a shutter screen/s that is embedded in the visual mechanism of the headmount and/or moves back and forth rapidly so that the eye/brain of the user/s does not register its movement. When the shutter screen is closed, the user is interacting in one of the active modes. When the shutter is open, the user/s are seeing the common screen in passive mode.

In addition, in order for the visual mechanism of the headmount to switch between operations in these embodiments, it is controlled by the computerized system/s and/or server/s and/or manual functions that communicate with one or many lenses and/or screens and/or panels that are: i. made from a material such as OLED, LCD, polarized glass, Frenzel lens, metamaterials or any other material that enables the required operations, ii. controlled by software and/or sensors and/or physical function and/or digital signals such that the visual mechanism tints and/or changes color and/or changes viewing angle and/or changes response time and/or increases and decreases in transparency and/or turns opaque and/or distorts and/or polarizes light and/or configures light and/or disappears and/or any other method that enables the required operations, iii. controlled by software and/or physical function and/or digital signals such that the lenses within the visual mechanism are able to move and/or overlap and/or be configured and/or any other means to enable any or all operations to function, iv. controlled by software and/or physical function and/or digital signals such that it accommodates the different resolutions and/or rate of pixels and/or screen sizes and/or any other requirement of the different operations, v. fitted with hardware such as LED lighting, mirrors and/or any other hardware which is controlled by software and/or digital signals such that it enables the different operations to function, vi. fitted with a shutter screen that is controlled by software and/or sensors and/or physical function and/or digital signals such that it can move back and forth to allow a seamless transition between the different operations, and/or vii. configured to use some or all of the above points in different combinations and/or any other system/s or method/s that allow the visual mechanism to enable any or all operations to function.

In the most preferred embodiments, the headmount is fitted with a manual button and/or digital functions and/or analogue functions that allow the user/s to switch between the different operations of the visual mechanism.

In certain embodiments of the predetermined timelines, the predetermined timeline software/s and/or program/s and/or function/s and/or system/s further comprise: i. one or more layers, ii. a time ruler and one or more playsticks that display a representation of time within the timeline and which time ruler runs from left to right, iii. executable functions that organize and control the digital signals and/or content over time in both layers and frames, dividing lengths of time into frames, iv. an indication of where content and/or digital signals occur in the timeline, and/or v. one or more playsticks moving horizontally across the layers and frames of the timeline and the digital signals and/or content are sent or otherwise processed as a playstick activates them. In preferred embodiments, such layers of the timelines can be configured to control, activate, send, and/or receive digital signals and/or content to systems, servers, output devices, cinema devices, hardware devices, software, modes (e.g., a passive mode, a first active mode, a second active mode, a combination mode), modules, components and/or other timelines. In certain preferred timelines, the timeline embodiment can adjust its digital signals and data for each user or group of users. In certain preferred embodiments, the timelines can be changed and otherwise operated by a teacher (e.g., virtual or real), user, and/or software within a server.

In certain preferred embodiments, the system can use more than one timeline and the multiple timelines communicate with each other via software, wired or wireless technology, digital signals, a teacher (e.g., virtual or real), an action (e.g., physical, analog or digital) and/or an event. In preferred embodiments, the one or more timelines play or otherwise operate simultaneously, interchangeably, and/or separately within the cinema, room(s) or device.

An alternative and/or equivalent to a predetermined timeline of this invention can be a set of predetermined functions that play or otherwise operate in real-time such as, but not limited to, switching between different modes (e.g., switching between a passive mode, a first active mode, a second active mode, a combination mode, and/or some other mode).

Exemplary modes, including 1. Passive Mode, 2. First Active Mode, 3. Second Active Mode, and 4. Combination Mode, are described as follows:

1. Passive Mode

During the passive mode the one or more users each view the audio-visual content through one or more cinema/real environment devices.

In preferred embodiments of the passive mode, the system or a related server and the one or more timelines communicate with a headmount's individualized screen to switch into see-through glasses (e.g., they switch between functioning as 3D glasses or 2D glasses); speakers switch on and headphones switch off and/or switch into a uniform mode for all users; the microphone and camera switch off; the sensors with the out devices, such as interactive gloves, footwear or suits, switch off; and the user's attention is directed to the narrative of the film shown on a device (e.g., cinema screen, common screen, individual screen on a device). In certain preferred embodiments, the user/s can watch and/or interact with and/or experience the film in its entirety on the screen of a headmount, with no requirement for a common screen. The visual mechanism of the headmount can operate between VR mode and/or AR mode and/or MR mode and/or 3D mode and/or 2D mode and/or a combination of the modes.

In certain preferred embodiments, during the passive mode, the existing cinema devices may be configured to communicate with the film module and/or the computerized edutainment system/s and/or server/s to switch on and off as required in accordance with the timeline/s. In certain embodiments, the passive mode has a film narrative that is comprised of content that can be understood on many different levels, relative to the extent of achievement the user/s have attained in the VR and/or AR and/or MR modes.

2. First Active Mode

During the first active mode, the one or more users each (1) view the audio-visual content through a headmount and/or (2) interact with the audio-visual content through the one or more output devices. During this mode, the user/s is provided with an individual experience. The assessment module, the assessment compilation module and predetermined timeline communicate with the teaching interface and educational game module to send the appropriate content to the individualized screen and output devices based on the user/s feedback and/or preference. In certain embodiments, during the active mode, the user/s is provided with customized content based on their performance, but there are also elements that are similar to other user/s content.

During certain embodiments of the first active mode, an educational game performs some or all of the following functions: i. displays data from the teaching module, which is an element of the educational game module, via an interactive teaching interface to the user/s, obtains assessment feedback of understanding and/or performance of the user/s via an assessment module, iii. compiles obtained assessment feedback of the user/s, iv. compares an assessment profile of the user/s to a pre-determined desired assessment profile, v. operates in accordance with the time allotted by the timeline and/or the system/s and/or the teacher, and/or vi. determines any modification to the data of the teaching module in order to best support the unique learning needs of each user/s.

In preferred embodiments of the first active mode, the user actively participates with the VR, AR, and/or MR. The system, a related server, and/or the timeline function and/or software and/or program communicates with some or all of these steps/functions:

a. A headmount's individualized glasses and commands them to switch into individualized screen mode and function in VR, AR, and/or MR if and when required. The speakers switch into headphone mode and the microphone and/or camera is switched on, if and when required.
b. Output devices such as gloves, suits, footwear and other such devices interact with the assessment module through sensors, haptic, sonic, and/or any other wired or wireless technology. This interaction allows the user to send and/or receive digital feedback from the output devices and/or images that they view through their headmount.
c. The cinema devices and/or devices in any room during a group or individual experience such as, but not limited to, the projector, surround sound, common screen are switched on, if and when required.
d. The modules, such as but not limited to, the educational game module, the assessment module, the assessment compilation module and/or other components included in the system switch on if and when required.

In certain preferred embodiments of the first active mode, there will be key digital signals, analog signals, physical signals, images, and/or other triggers that let the user know that the mode is active.

In certain preferred embodiments of the first active mode, each seat and/or user and/or headmount has an individual frequency and/or channel and/or digital signal that may/may not require a login and/or password and/or serial number and/or any other means of identification. This frequency and/or channel and/or digital signal is provided to the user by the cinema and/or the computerized system/s and/or is automatically generated upon activation of the headmount and/or by the user and/or at the commencement of the film experience.

In certain embodiments of the first active mode, in the cinema and/or group environment there may be as few as one and as many as thousands of channels and/or frequencies and/or digital signals simultaneously available for use. In certain embodiments, in an online environment, there are infinite channels and/or frequencies and/or digital signals available for use.

In certain embodiments of the first active mode, the common screen and the surround sound in the cinema can simultaneously deliver audio-visual files, which are either in a loop and/or in a continuous flow. In certain embodiments, the common screen and the surround sound in the cinema could simultaneously deliver audio-visual files in passive mode (3D and/or 2D), so a user can opt to watch additional scenes of the film narrative delivered during those intervals instead of participating in the active mode. In certain embodiments, the common screen and the surround sound in the cinema can simultaneously deliver images or fixed scenes in passive mode so that the cinema screen and surround sound do not switch off but play continuously in the cinema.

3. Second Active Mode

During the second active mode, the one or more users each (1) view the audio-visual content through a headmount, (2) interact with the audio-visual content through the one or more output devices, and/or (3) interact with the audio-visual content through one or more cinema/real environment devices. During this mode, the user/s is provided with an individual experience. The assessment module, the assessment compilation module and predetermined timeline communicate with the teaching interface and educational game module to send the appropriate content to the individualized screen and output devices based on the user/s feedback and/or preference. In certain embodiments, during the active mode, the user/s is provided with customized content based on their performance, but there are also elements that are similar to other user/s content.

During certain embodiments of the second active mode, an educational game performs some or all of the following functions: i. displays data from the teaching module, which is an element of the educational game module, via an interactive teaching interface to the user/s, ii. obtains assessment feedback of understanding and/or performance of the user/s via an assessment module, iii. compiles obtained assessment feedback of the user/s, iv. compares an assessment profile of the user/s to a pre-determined desired assessment profile, v. operates in accordance with the time allotted by the timeline and/or the system/s and/or the teacher, and/or vi. determines any modification to the data of the teaching module in order to best support the unique learning needs of each user/s.

In preferred embodiments of the second active mode, the user actively participates with the VR, AR, and/or MR. The system, a related server, and/or the timeline function and/or software and/or function and/or system communicates with some or all of these steps/functions:

a. A headmount's individualized glasses and commands them to switch into individualized screen mode and function in VR, AR, and/or MR if and when required. The speakers switch into headphone mode and the microphone and/or camera is switched on, if and when required.
b. Output devices such as gloves, suits, footwear and other such devices interact with the assessment module through sensors, haptic, sonic, and/or any other wired or wireless technology. This interaction allows the user to send and/or receive digital feedback from the output devices and/or images that they view through their headmount.
c. The cinema devices and/or devices in any room during a group or individual experience such as, but not limited to, the projector, surround sound, common screen are switched on, if and when required.
d. The modules, such as but not limited to, the educational game module, the assessment module, the assessment compilation module and/or other components included in the system switch on, if and when required.

In certain preferred embodiments of the second active mode, there will be key digital signals, analog signals, physical signals, images, and/or other triggers that let the user know that the mode is active.

In certain preferred embodiments of the second active mode, each seat and/or user and/or headmount has an individual frequency and/or channel and/or digital signal that may/may not require a login and/or password and/or serial number and/or any other means of identification. This frequency and/or channel and/or digital signal is provided to the user by the cinema and/or the computerized system/s and/or is automatically generated upon activation of the headmount and/or by the user and/or at the commencement of the film experience.

In certain embodiments of the second active mode, in the cinema and/or group environment there may be as few as one and as many as thousands of channels and/or frequencies and/or digital signals simultaneously available for use. In certain embodiments, in an online environment, there are infinite channels and/or frequencies and/or digital signals available for use.

In certain embodiments of the second active mode, the common screen and the surround sound in the cinema can simultaneously deliver audio-visual files, which are either in a loop and/or in a continuous flow. In certain embodiments, the common screen and the surround sound in the cinema could simultaneously deliver audio-visual files in passive mode (3D and/or 2D), so a user can opt to watch additional scenes of the film narrative delivered during those intervals instead of participating in the active mode. In certain embodiments, the common screen and the surround sound in the cinema can simultaneously deliver images or fixed scenes in passive mode so that the cinema screen and surround sound do not switch off but play continuously in the cinema.

4. Combination Mode

During the combination mode, two or more of the passive mode, the first active mode, and/or the second active mode operate simultaneously.

Assessment Modules

The assessment modules receive data (e.g., feedback) from the one or more users via their one or more output devices and execute functions that comprise: i. receiving data from each of the one or more output devices, ii. assessing the data from the output devices and other inputs of each of the one or more users against predetermined parameters from the educational game module and/or teaching interface in real time, and iii. providing feedback data to an assessment compilation module. In preferred embodiments, the assessment module also communicates feedback data in real-time to the educational game module and/or the teaching interface.

In certain preferred embodiments, if the user/s has not reached a certain level of achievement in the educational game within the allotted time, the assessment module allows the user to move forward either onto the next instruction, if the mode is still that of active participation, or onto the narrative, if the mode is switching to that of passive mode, as is governed by the predetermined timeline and/or related software and/or program and/or function and/or system/s. In certain preferred embodiments, the digital signals received by the assessment module from one or more VR and/or AR and/or MR output devices fitted with sensor and/or haptics may include information about which key has been pushed (pitch), time duration of the key being pushed (timing), and the pressure applied to the key being pushed (dynamics), and/or about the movement of the fingers and/or hands and/or arms of the one or more users. The data received by the assessment module from audio feedback may include information about the pitch and/or quality and/or volume and/or duration and/or rhythm and other parameters of the singing voice. It may also include audio data signals from vocal answers and/or vocal commands sent through the microphone.

Assessment Compilation Modules

The assessment compilation modules execute functions that comprise compiling feedback data from the assessment modules and each of the one or more output devices in the form of the output device data and sending the feedback data and the output device data to an educational game module. In certain preferred embodiments, the assessment compilation module, along with the educational game module, allows the user to progress in their VR and/or AR and/or MR game.

Educational Game Modules

The educational game modules comprise a teaching module, a personalized module and a submodule. The educational game module executes functions that comprise modifying data from the teaching module in response to the feedback data, user feedback and the output device data received from the assessment compilation module and the personalized module, in accordance with instructions from the one or more predetermined timelines. The educational game module (and the teaching interface) teaches the user/s music and/or any other educational topic and/or game and/or skill and/or knowledge in any subject.

In preferred embodiments, the educational game module is filled with multiple visuals, video-clips, audio-clips, animations, data and images. All three modules in the educational game module (i.e., a teaching module, a personalized module and a submodule) work together and integrate in order to send custom-made data/instructions to the teaching interface, which then sends said custom-made data/instructions to each user, based on their performance and competency.

In certain preferred embodiments, the teaching interface and educational game module will keep pace with the user/s' performance and respond accordingly. For example, the educational game module of these embodiments may repeat the same subject matter at a slower pace either once or many times, or accelerate the pace, or teach further subject-matter. The system/s operate in this way based on the feedback from the assessment module/s in conjunction with the predetermined timeline/s.

In certain embodiments, the educational game module and/or its related module/s and/or interface/s and/or database/s and/or server/s and/or system/s can be accessed online or in any room either with or without the passive mode.

Teaching Modules

The teaching modules comprise content to be taught and/or provided to each of the one or more users. In the most preferred embodiments, the teaching module comprises one or more educational topics and/or game and/or skill and/or knowledge in any subject in various levels, complexities, styles and variations.

Personalized Modules

The personalized modules comprise personal information and data for each of the one or more users and/or user feedback for each of the one or more users. Examples of such information in preferred embodiments include information concerning a user's competency and/or level of performance.

Submodules

The submodules execute functions that comprise storing data that is required by an instruction and/or interaction from each of the one or more users. In preferred embodiments, the sub-module stores a wide spectrum of related topics for a specified subject matter.

Assessment Databases

The assessment databases comprise digital storage facilities that store input, feedback, instructions, interactions and/or results from each of the one or more users. In preferred embodiments, this digital storage facility can be accessed by the user from any computer or system once they input their login name and/or email and/or ticket number and/or cinema seat number and/or any other details that are required by the software.

In certain preferred embodiments, the assessment database in a music educational game is organized under different headers such as (but not limited to) technicality, musicality, song repertoire, sight reading, theory, performance flair, which allows the user/s to know their strengths and weaknesses within each area of the game.

Output Devices

One or more output devices comprise devices that may have embedded haptic, sensor, sonic, midi, and/or magnetic tracking capability, and may include personal audio-visual components, wearable devices with headmounts, gloves, footwear and/or suit hardware, keyboards, mouse, joystick, game controllers, touchscreen, graphic tablet and the like, and devices that communicate digital data, including output device data, pertaining to each of the one or more users. Output devices can also comprise audio-visual devices and personal audio-visual components such as cameras, microphones and the like, or combinations of any of these.

In certain preferred embodiments, a VR and/or AR and/or MR keyboard is visually accessed through the headmount and played with or without gloves using haptic and/or sonic and/or visual input and/or other such technology, which gives the user/s tactile feedback and/or audio feedback and/or visual feedback and/or sensory feedback when pushing the keys on the keyboard within the cinema and/or any room by one or up to thousands of users. In certain embodiments, a virtual keyboard is used that is played with or without gloves, which has sensors and/or hardware technology and/or software technology and assesses each user/s performance.

In certain embodiments, the headmount is lightweight, tethered or untethered, is controlled by the computerized edutainment system/s and is operated through wireless technology. The headmount interacts with the computerized edutainment system by sending and receiving feedback. It may include some or all of the following features: (1) glasses and/or lens/es and/or screen/s that can switch between passive mode (2D and/or 3D) and active modes (AR and/or VR and/or MR); (2) high quality and surround sound headphones, wherein the user/s can also hear the surround sound speakers of the cinema or home environment through their headphones when they are switched off or on reduced volume or/and hear the sound content through both the speakers and headphones; (3) a microphone, which allows the user/s to hear their own voice and, when singing, to hear their voice and pitch and also interact with the VR and/or AR and/or MR content, wherein the microphone also sends signals to the assessment module and/or other game module/s; (4) a camera to allow for AR and/or VR and/or MR interaction; and/or (5) a wireless and/or wired receiver.

In certain embodiments, the glove/s are fitted with haptic or other such technology that enables the user/s to interact with AR and/or VR and/or MR. The glove/s comprise one and/or two, five-fingered data glove/s that track finger and/or hand positions and/or postures and use micro-speakers to create simulated vibrations and sounds. It enables tactile feedback and/or force feedback and/or motion tracking. The glove is fitted with sensors or other such technology and sends and receives feedback from the gaming module/s.

In certain embodiments, other output devices such as a suit, footwear and socks are fitted with haptic, sensor, sonic and/or other such technology. In certain embodiments, the user/s control and influence their movement within the AR and/or VR and/or MR environment through eye movement and/or body position and/or movement and/or voice command and/or any other means necessary. In certain preferred embodiments, hardware devices are loaded with system software/apps and/or are compatible and/or communicate with the system/s and its component(s), such as but not limited to, keyboards, controllers, phones, laptops, tablets, and speakers.

In preferred embodiments, in order to participate in the active modes, the user/s can operate hardware device/s and/or output device/s that are directly attached to the system/s via wired and/or wireless technology, and/or communicate with the system/s using midi and/or sensors and/or other such technology.

Cinema/Real Environment Devices

One or more cinema/real environment devices or cinema devices. Each such device can be or comprise a common screen for multiple users, a personal screen, a headmount, other displays, computers, laptops, gaming consoles, tablets, watches, telephones, speakers, a camera, a microphone, a projector, other such presentation, a voltage and frequency stabilizer, viewing or audio-video devices, and/or combinations thereof. These devices may provide the functions and interactions necessary to operate the system.

Hardware To Access Networks

The educational and entertainment systems may access local area networks, the internet, or other networks, by wired connections or wireless connections. Particularly preferred are wireless connections to the internet to access servers that contain embodiments of the educational and entertainment system.

Certain Configurations Of Embodiments Of The Invention.

Certain of the embodiments of this invention can be configured to function for an individual user as well as thousands of users at the same time within a single room, such as a cinema, and also within many rooms, such as with a practically unlimited number of online users.

Certain of the preferred embodiments of this invention can enable the one or more users to experience a method that redefines the learning process and changes the modality of conventional film watching to one that includes both a passive and active experience—i.e., the ability for a user to follow the storyline from a single-point of view (passive mode) and then switch into creating and/or co-creating their own environment and/or interacting and/or influencing the story in multiple ways with a multi-directional and/or an open-ended game, where the user/s guide the game and/or story and/or reality (active modes), and then going back and forth between the two.

Certain of the most preferred embodiments of this invention enable the one or more users to experience a music learning system that is delivered in VR, AR, and/or MR (or combinations of two or three of these) along with a film narrative that is delivered in 2D and/or 3D, in a cinema, one or more rooms, and/or online.

### Example 1: Predetermined Timeline System(s) or Server(s) Embodiments

In these embodiments, a computerized educational and entertainment system(s) or server(s) is provided that operates (e.g., uses computer executable instructions and one or more memory devices) according to one or more predetermined timelines. The system(s) or server(s) and the one or more predetermined timelines operate in tandem and have at least four distinct modes (e.g., a passive mode, a first active mode, a second active mode, a combination mode).

In these embodiments, the system(s) or server(s) can be configured to have additional components (e.g., modules, devices) and have one or more computer executable functions. These may include, for example, a film module and an educational module.

### Example 2: Certain Preferred Embodiments

In one particularly preferred embodiment, a computerized educational and entertainment system for one or more users is provided, wherein the system comprises (1) a film module comprising audio-video content; (2) one or more active modes comprising the computer executable functions of providing interactive teaching of subject matter to each of the one or more users; (3) an educational game module comprising the computer executable functions of providing input, feedback, instructions, interactions, and/or results from each of the one or more users to the system; and (4) wherein the audio-video content from the film module is played to the one or more users and interrupted by the one or more active modes at one or more set times to provide the interactive teaching of subject matter to each of the one or more users, and wherein each of the one or more users can provide input, feedback, instructions, interactions and/or results to the system. In this preferred embodiment, the audio-video content is in the form of a narrative film and the system resides on one or more servers that is accessed by a user using a headmount. The interactive teaching is adjusted in difficulty level according to the user's ability to respond correctly (or incorrectly) to the interactive teaching. The system is provided and accessed over a wireless communication system.

In another particularly preferred embodiment, a method of teaching subject matter to one or more users is provided that comprises (1) providing a film comprising audio-video content to the one or more users using a computerized educational and entertainment system, this system comprising one or more modules and one or more computer executable functions; (2) interrupting the film one or more set times with one or more active modes using the computerized educational and entertainment system and computer executable functions of providing interactive teaching of subject matter to each of the one or more users; and (3) providing input, feedback, instructions, interactions, and/or results from each of the one or more users to the computerized educational and entertainment system using an educational game module. In this preferred embodiment, the audio-video content is in the form of a narrative film and the system resides on one or more servers that is accessed by a user using a headmount. The interactive teaching is adjusted in difficulty level according to the user's ability to respond correctly (or incorrectly) to the interactive teaching. The system is provided and accessed over a wireless communication system.

### Example 3: Mastertude Film/System Embodiments

We now further describe certain examples of preferred embodiments of this invention that are collected together and called Mastertude herein. These embodiments, including preferred embodiments of modules and computer executable functions, and the embodiments of Examples 1 and 2, and alternatives of all of these, can be applied to the Mastertude embodiments but also other embodiments of the invention. These embodiments can be used in methods of teaching subject matter to users (e.g., students).

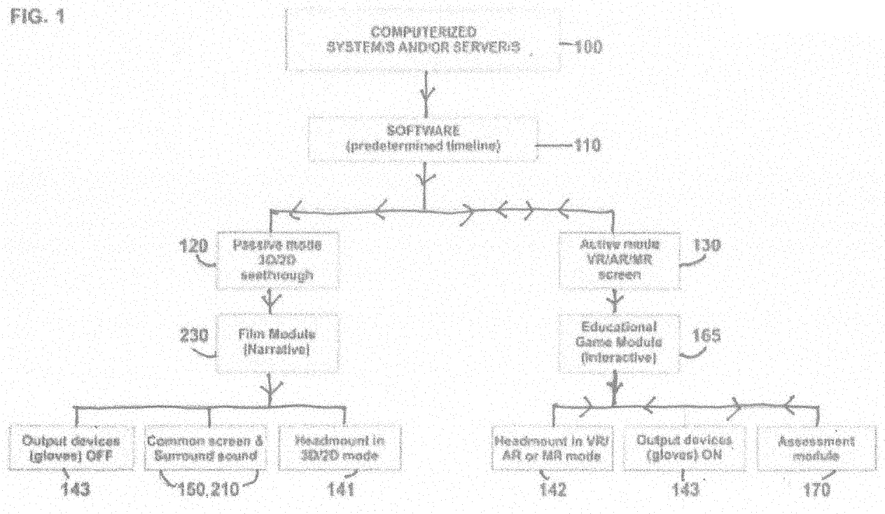

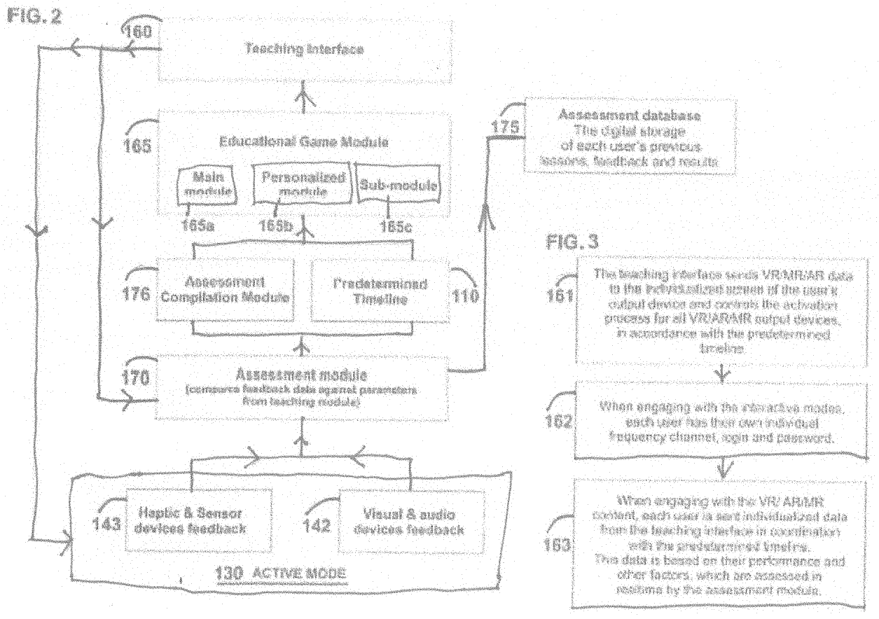

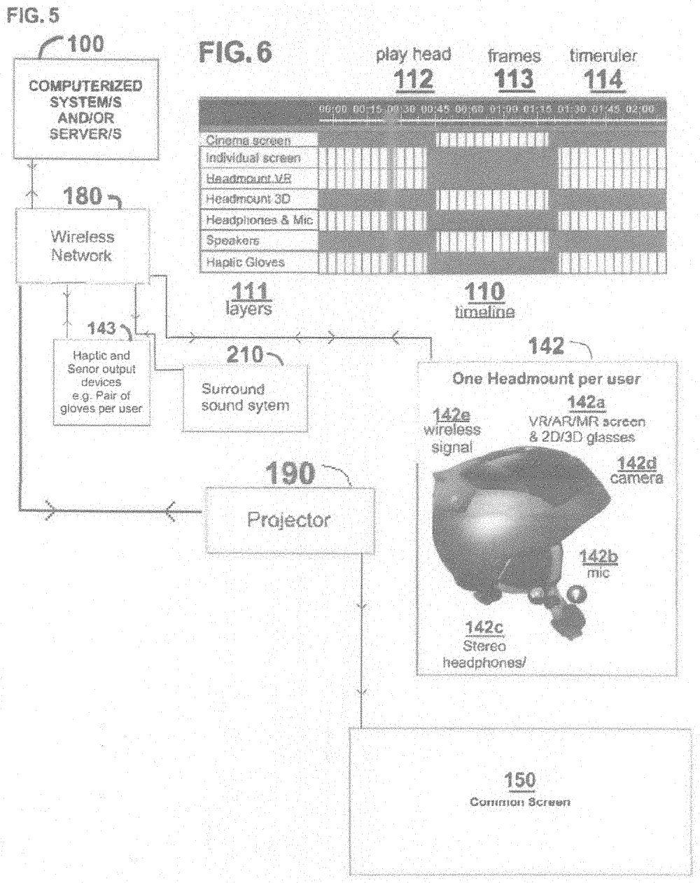

Some or all of the components and processes of these embodiments of Mastertude interact with a predetermined timeline 110 that sits within a master computerized system/s and/or server/s 100 as shown in FIG. 1 and in a cinema model FIG. 5. This system switches between a film narrative 230 (passive mode 120) and an educational game module 165 (active mode 130) to maximize learning.

The preferred embodiments of Mastertude relate to a computerized system/s and/or server/s 100 that communicates over a wireless network 180 and sends digital data to a big screen/cinema 210, screen/home screen and/or the output devices 142, 143 of individual users to create passive entertainment, active entertainment, passive education and/or active entertainment using audio-visuals, VR, AR, MR, 3D, 2D, as well as haptic, sensors and gaming technology. The digital data is governed by a predetermined timeline 110, which controls when the computerized system/s and/or server/s 100 switches between the passive mode 120 of a film narrative 230 in 3D or 2D and an active mode 130 of an educational game 165, which incorporates virtual reality, mixed reality and/or augmented reality.

When the system switches between a film narrative 230 (passive mode 120) and an educational game module 165 (active mode 130) if there are minor fluctuations in frequency and/or voltage between any or two or more system/s and/or different devices, a voltage and frequency stabilizer is used.

In certain embodiments, the Mastertude system/s and server/s 100 combines an accelerated music educational game with a compelling and thrilling narrative.

The Mastertude Passive Modes

In the passive mode 120 of preferred embodiments of this example, the computerized system/s and/or server/s 100 and/or the film module 230 sends audio-visual digital signals to the cinema/real environment devices 150, 190, 210.

In certain embodiments, the film module 230 is configured and communicates with the existing cinema system/s and device/s, telling or otherwise signaling them when to switch on and off in accordance with the timeline.

In certain embodiments, the film module 230 sends 3D/2D audio-visual data signals, which are based on a predetermined timeline 110, to a cinematic screen 150, home screen, individualized screen or any screen and/or sound system 210 within a cinema and/or in any room or location, with/without a projector 190 over a wireless network 180.

In preferred embodiments, the computerized system/s and/or server/s 100 configures the multiple immersive output/input devices 142, 143 to switch into passive mode 120, i.e., the headmount's individualized screen 142a switches between functioning as 3D glasses 141 or 2D glasses; the common speakers 210 switch on and the headphones 142c switch off and/or switch into a uniform mode for all users, the microphone 142b and camera 142d switch off, the sensors within the output devices 143—such as interactive gloves, footwear, or suit—switch off and the user/s attention is focused on the narrative of the film on the cinema screen 150/home theatre screen/users' personal device.

The Mastertude Active Modes

In the active mode 130 of preferred embodiments of this example, the user/s actively participate in the VR (Virtual Reality) and/or AR (Augmented Reality) and/or MR (Mixed Reality). The Mastertude computerized system/s and server/s 100 and/or the educational game module 165 sends audio-visual digital signals over a wireless network 180 to multiple immersive output devices 142, 143.

In certain embodiments, each user is provided with a headmount 142 that is outfitted with gadgets such as, but not limited to, an individualized screen 142a, a microphone 142b, headphones 142c, a camera 142d and a wireless receiver 142e.

In certain embodiments, the computerized system/s and server/s 100 send and/or receive digital visual data to the individualized screen 142a and the camera 142d of the headmount, and digital audio data is sent and/or received from the headphones 142c and the microphone 142b. The timeline 110 and the educational game 165 determines when the headmount gadgets 142a, 142b, 142c, 142d are switched on and off, if and when required.

In this embodiment, each user is provided with a headmount 142, which provides them with an immersive/interactive environment. The user/s receive a Virtual Reality experience through the individualized screen 142a and headphones 142c. The user/s interact with the Virtual Reality data through output devices 143, and/or the microphone 142b, which is assessed by the assessment module 170 using haptic, sensor, sonic, midi, magnetic trackers or other such technology.

In other words, in these embodiments the user/s are provided with output devices 143 such as gloves, suits, footwear or other such output devices. These output devices 143 send digital feedback to the assessment module 170 (through sensors and/or using haptics and/or sonic and/or midi and/or magnetic trackers and/or any other technology that allows the user/s to send feedback) as the user/s interact with the audio-visual data received through their individual headmount screen 142a and headphones 142b. For example, a glove/gloves that is fitted with haptic technology and/or sensors and/or midi and/or other technology would allow each individual user to play the virtual keyboard and give each user an experience of playing a 3D virtual reality keyboard when they look through the VR headmount screen. When the user/s play the keyboard it provides real-time feedback and sound to each user, making the users' experience as real as if they were playing a hardware keyboard. The gloves send feedback to the assessment module 170, which assesses elements such as 1) which key has been played and pressed (pitch), 2) the time duration of the press, 3) the level of pressure applied on the one or more keys of the user's device by the one or more users, 4) whether the dynamics are loud or soft and 5) the position and movement of the fingers of the one or more users on the one or more keys.

In preferred embodiments, the multiple immersive output devices 142, 143 output Virtual reality, augmented reality or mixed reality audio-visual content, and interact with the teaching interface 160, educational game module 165, assessment module 170 and predetermined timeline 110.

In certain embodiments in a cinema and/or a group setting, either online or within a room, where there is more than one user, the active mode provides each user within the group with an individual experience. The multiple output devices 143 such as gloves, footwear, suits and other such output devices that are fitted with haptics, sensors, sonic, midi, magnetic trackers or other technology, may be worn by cinemagoers as in FIG. 5 or users at home so that the user/s' performance can be assessed during the active mode/s 130. The assessment module 170, predetermined timeline 110 and educational game module 165 send the appropriate content to the teaching interface 160, which sends individualized content to the output devices 142, 143. For example, in an educational VR environment, if one user is learning significantly faster than another user, they will experience different content and/or images to the user that was learning at a slower pace. This distinction is managed within the predetermined timeline of the film to avoid any disruption to the flow of the film.

The data recorded by the assessment module 170 in preferred embodiments compares the data received from each user with pre-determined parameters that are retrieved from the educational game module 165. Consequently, the assessment module 170 determines the user/s level of proficiency in the subject being taught in each teaching module 165a and, based on that level and the time allotted by the predetermined timeline 110, more data and/or content is retrieved from the educational game module 165 and sent to the teaching interface, which sends this data to the user.

In certain embodiments, each user is assessed and digital data is sent and received by the output devices 142, 143 at the individual's pace, within a predetermined timeframe. For example, if the individual is a quick learner, they may be able to play multiple songs, while another individual can only play one song. If the individual is a slow learner, the timeline 110 moves them along and helps them cover each topic theoretically, so they are not left behind. Those who are not interested in participating in this virtual reality experience can choose an alternative virtual reality experience, for example, the visiting of other worlds.

In other words, in these embodiments the teaching interface 160 sends VR/MR/AR data signals to the individualized screen 142a and the user's output devices 142, 143, and also controls the activation process for all VR/AR/MR output devices 142, 143, in accordance with the predetermined timeline 110, 161. The system transmits the data signals to the multiple immersive output devices 142, 143—as few as one and as many as thousands—simultaneously, so that each of the user/s has their own individual frequency channel, login and password 162. Each user is sent individualized data from the teaching interface 160 in coordination with the predetermined timeline 110, and thus they experience a subjective but similar immersive visual experience. The unique data received by the user is based on their performance and other factors, which are assessed in real time by the assessment module 170, 163. The timeline 110 keeps the virtual experience of the group or two or more users moving along, based on the predetermined timeframe required.

The user/s cannot stretch the timeline 110 according to their own desires when in a group environment. They have to return to the passive mode 120 as is predetermined by the system's timeline 110 after the time allotted in the active mode 130 is up.

The computerized system/s and or server/s 100 of certain embodiments can be configured to allow thousands of users to participate in the virtual reality environment and/or active mode 130 simultaneously. Each user can interact with the environment in their own, subjective way, based on ongoing assessment and feedback received from the user. For example, during the lesson, the virtual environment allows users to either participate in the educational game or to choose to visit an alternate reality/world. Each user is creating their path during the active mode 130 and can interact in their own unique way for the duration of the predetermined timeline 110 of active mode 130 interactivity.

In certain embodiments, during the active mode 130, the common screen 150 and the surround sound 210 in the cinema 200 are simultaneously delivering audio-visual files, which are either in a loop or in a continuous flow, so that the user/s who takes off their headmount 142 remains part of the environment and continues to be entertained.

In certain embodiments, during the active mode 130, the common screen 150 and the surround sound 210 in the cinema 200 simultaneously deliver an image or images; the sound is muted or soft and synchronized, i.e., the active mode 130 and the passive mode 120 play simultaneously and are synchronized.

In certain embodiments, the computerized system 100 allows the user/s to participate in the virtual reality environment by creating their own subjective reality during the active mode 130.

In certain embodiments, the user/s can engage in two-way audio and/or visual communication with one or more of the other users if required and/or desired.

In certain embodiments, in an individual setting, where there is one user participating in the Mastertude edutainment system, the user can stretch the timeline 110 according to their own desire.

Mastertude's Switching Between Active And Passive Modes

The computerized system/s and/or server/s 100 of preferred embodiments of this example control the switch between a passive mode of viewing a film narrative and the active mode of interacting with the educational game and/or film narrative within a cinema or any other room for one or more users.

In certain embodiments, the edutainment computerized system/s or server/s 100 operate according to a predetermined timeline 110 and switch the system into four distinct modes:

1. Passive mode 120: where the user/s views the audio-visual content in 2D and/or 3D, either through their headmount 141 or via the common screen and common speakers.
2. Active mode #1 130: where the user/s view and interact with the content through output devices 142, 143 in VR/AR/MR mode.
3. Active mode #2 130: where the user/s view and interact with the content in VR/AR/MR, with cinema/real environment devices 150, 180 and/or output devices 142, 143 and/or other devices.
4. Combination mode: Where one or more of the elements of passive mode 120 and/or active mode #1 and/or active mode #2 130 operate simultaneously.

In certain embodiments, the predetermined timeline 110 comprises one or many layers 111 and a Time Ruler 114, which displays time with various increments and can magnify and minimize into hours, minutes, seconds, milliseconds and further as you zoom in and out. The Time Ruler 114 goes from left to right. The timeline 110 organizes and controls the digital signals and content over time in layers 111 and frames 113. It divides lengths of time into frames 113. The timeline 110 shows where content occurs in the timeline 110, including frame-by-frame content. The playstick 112 moves horizontally across the layers 111 of the timeline 110 and digital signals of the frames 113 are sent as the playstick moves across them. Each layer 111 of the timeline 110 can be configured to control different devices and/or system/s and/or server/s such as, but not limited to, output devices (one or more output devices each comprising haptic, sensor, sonic, midi, magnetic trackers, personal audio-visual components, hardware, headmounts, gloves, footwear and/or suit devices communicate digital data for the one or more users), cinema/real environment devices (one or more cinema/real environment devices, such as a common screen for multiple users, a personal screen, other displays, computers, laptops, gaming consoles, tablets, watches, telephones, speakers (e.g., a surround sound system), a camera, a microphone, a projector, other such presentation, viewing or audio-visual devices, and/or combinations thereof), other hardware devices, software/s, mode/s, modules, etc.

These layers 111 of the timeline 110 can be configured based on the system. To explain this system, we have drawn a rough concept diagram of the timeline, FIG. 6, which is an example, but the timeline is not limited to this design. In the concept diagram, the layers 111 will switch the devices on and off and/or send digital signals to the appropriate system/s as the playstick 112 moves horizontally across the layers 111 of the timeline 110. Based on the mode required, the timeline 110 automatically controls and sends the required data signals to the appropriate output devices 142 143, while the playstick 112 of the timeline 110 moves forward. In the example of FIG. 6, when the playstick 112 starts to play, it comes across content in layers 111a, and 111f thus sends audio-visual digital signals to the common screen 150, the headmount 141 and the surround sound system 210 to switch into passive mode 120. As the playstick 112 progresses horizontally on the timeline 110 and reaches a certain point in the time ruler 114 and time frame 113, it comes across data in layers 111b, 111c, 111d, 111e thus, sending digital signals to the headmount 142 screen 142a, headphones 142c, microphone 142b and the haptic/sensor output devices 143 to switch on, thereby switching into active mode 130. The predetermined timeline 110 also commands the educational game module 165 and assessment module 170 to switch on during the active mode 130.

In certain embodiments, the timeline 110 could comprises layers 111 that control software/s, system/s or module/s within the computerized system/s 100, which further control the different devices and digital signals in the cinema 200.

In other embodiments, there could be more than one timeline that communicate with each other and play simultaneously and/or interchangeably within the cinema 200 or in any other room.

In certain embodiments if there is only one user operating the system 100, the user can choose to change the timeline 110, according to their personal preference.

The headmount 142, in preferred embodiments is fitted with a screen that switches back and forth to glasses, in accordance to the timeline, so that the user/s can: 1) view the passive mode 120 visuals through 3D or 2D glasses 141 on the cinema screen 150 or common screen, and 2) view the active modes' 130 viewing elements of VR, AR and MR, on their individual screen 142a.

In certain embodiments, the headmount glasses 142a are controlled by the computerized system/s and/or server/s 100 in accordance with the timeline 110, which communicates with the 3D lens or series of lenses that, are: 1) made up of OLED material, LCD, polarized glass, Frenzel lens, metamaterials or any other material and/or 2) software controlled, such that the lense/s tints and/or increases and decreases in transparency and/or turn opaque and/or distorts and/or polarizes light and/or changes viewing angle and/or changes response time and/or configures light to switch between viewing visuals in Virtual Reality on the lens and/or series of lenses that act like a screen, creating clear visuals and wide field view in active mode 130, or so that the lenses switch into see-through glasses, i.e., the user can see images in 3D and/or 2D on the common screen 150 using the same lens, during the passive mode 120. The lenses can also be configured such that the user can view the common screen visuals when in AR or MR mode.

In certain embodiments, for the shift between an individual 142a and the common screen 150, the master computerized system 100 sends a signal to a shutter screen that is embedded in the glasses on the headmount 142, which allows the glasses to switch between operating as a screen that may or may not be opaque and see-through glass. The shutter screen moves back and forth rapidly so that the eye/brain of the user/s does not register its movement. When the shutter screen is closed, the user/s is interacting in active mode 130 and/or viewing an individualized screen 142a. When the shutter is open, the user/s are seeing the common screen 150 in passive mode 120, through the see-through 3D/2D glasses 141.

In certain embodiments, the computerized system 100 contains software that communicates over a wireless network 180 with the headmount glasses 142a, 141 via a software program and/or inbuilt app, in order to configure it to switch between see-through 3D/2D glasses and/or a screen to view VR/AR or MR. This effect can be exaggerated by controlling elements of the room, such as lighting and shadows and/or controlled by hardware within the headmount 142 such as LED lighting, mirrors, etc.

During the passive mode 120 of certain embodiments, the headmount screen 142a switches to see-through glasses 141 on the headmount 142. The gadgets on the headphone 142 such as microphone 142b, headphones 142c and camera 142d on the headmount 142 and other output devices 143 are switched off by the master computerized system/systems 100 and software, which is following a predetermined timeline 110, while the surround speaker system 210, projector 190 and common screen 150 are turned on.

During the active mode 130 of certain embodiments, output devices 142, 143 that are required for a particular educational game module 165 and/or assessment module 170 are switched on by the master computerized system/s and/or server/s 100 and software, which is following a predetermined timeline/s 110. When transitioning to the active mode 130, the speakers need to switch from a coordinated speaker system 210 to that of headphone mode 142c, so the user/s can hear their individual contribution.

In certain embodiments, the computerized system 100 switches multiple output hardware devices such as keyboards, controllers, phones, laptops or other relevant matter or objects that are loaded with Mastertude software/apps and/or are compatible and/or communicate with the Mastertude system/s, in accordance with the timeline/s 110.

When switching from an active mode 130 to a passive mode 120, the primary goal in the most preferred embodiments is to have a seamless transition between the different modes. The transition from one mode to the next should be so smooth that the user/s do not notice any difference in audio/visual quality at any time, especially when the mode switches from the big screen 150 to the individualized screens 142a or vice versa. In certain embodiments, there are overlapping frames/images that play simultaneously and/or a continuation of a scene during the transition, and/or any such systems to ensure that the visuals and audio maintain continuity. The VR visuals supplement and/or duplicate and/or replace the frames of the film on the common screen 150, making the transition from the big screen to the individualized screens 142a seamless.

In certain embodiments, the common screen 150 and the surround sound 210 remain on; they don't switch off but play continuously in the cinema 200. The film module 230 is layered on top of the active mode 130. The film module 230 comprises an image or images or a fixed scene, which plays on the common screen 120 and the surround sound 210 is reduced or muted for the duration of the active mode 130. After the active mode 130, the common screen 150 plays visuals and the audio on the surround sound 210 is increased for the passive mode 120.

In certain embodiments, the user/s will know that they can interact when it is in active mode 130 because, when the audio-visuals go into active mode 130, there will be key signals, which the user/s can recognize. For example, in the music teaching system, the trigger could be a scene in a music theatre with the professor in front of the class—i.e., whenever the user/s see this scene they are aware that the mode has transitioned from passive mode 120 to active mode 130. This would allow the user/s to know that it is time to participate by playing the keys of a music VR keyboard with haptic gloves 143. Another trigger/signal could be a slight change in color and/or buttons that appeared on the side screen, giving users the opportunity to choose their environment, or other such options, which allow them to participate in the lesson or exit the music-theatre to learn another lesson and/or play a predetermined VR game from the educational game module 165 within the timeframe allotted to the active mode 130 by the predetermined timeline 110.

In certain embodiments, the active mode 130 has an impact on the film narrative (the passive mode 120) when for an individual user. There are one or more than one film narrative options stored in a film database, and based on the interaction during the active modes, the film module 230 selects an audio-visual file from the film database, giving each user an individualized film narrative and experience. For example, the user is an intern in a forensic lab, and in the VR Educational game they must duplicate DNA and find a killer from the police database with the help of a lab scientist. If the intern performs the task when it switches into passive mode, the film module 230 could choose the audio-visual file from the film database in which the killer had an accomplice and the story continues. If the user doesn't manage to find the killer during the active mode, the film module 230 could choose the audio-visual file from the film database in which, the same killer kills his next victim.

In certain embodiments, the passive mode has a film narrative that is comprised of content that can be understood on many different levels, relative to the extent of achievement the user/s have attained in the VR and/or AR and/or MR modes.

In certain embodiments, the active mode 130 has no impact on the film narrative (the passive mode 120). For example in the music teaching system, the participation of the user/s and their music abilities has no impact on the film narrative (passive mode 120).

In certain embodiments, to maintain the film narrative's consistency and uniformity when in passive mode 120, the timeline 110 communicates to the system/s 100 in active mode 130 to send data files based on the user/s performance before the system/s 100 switch into the passive mode 120. For example, in the forensic lab, user one as the intern duplicates the DNA and finds the name of the killer, while user two, as another intern, doesn't complete the task and so doesn't find the name of the killer within the time allotted by the timeline. User two could be sent an audio-visual file a few seconds before the switch from active mode in which the lab scientist performs user two's task and finds the name of the killer. This process enables both user one and user two to leave the active mode at the same position; their lab has found the killer's name before the edutainment film system/s switches into passive mode.

In certain embodiments, the passive mode 120 from the film module 230 plays continuously in the cinema 200 and the active mode 130 is layered in the timeline 110 on top of the film module 230. The active mode 130 starts and stops at precise moments on the time ruler 114 of the timeline 110. When the playstick 112 comes across the active mode 130 content on the layers 111, the volume of the surround sound system 210 is reduced. The user/s who are not interested in interacting with the active mode 130 can continue to watch the film module 230 if they choose by manually switching their headmount 142 back into passive mode 141, which digitally changes when the playstick 112 moves over the frame 113 in active mode 130.

In certain embodiments, in an individual setting with a single user, the entire film narrative and the educational game is viewed with the headmount. In these embodiments, the content of each element is shot specifically for the different modes (e.g., cinematic mode, 360 mode, VR mode, AR mode, 3D mode, 2D mode, MR mode or any other mode), based on the mode required. The required section interacts with the software program and/or an inbuilt app within the computerized system 100 that is designed to run that mode, resolution and screen size, sending digital signals of the required mode to the output devices 142, 143 in real-time, based on the predetermined timeline 110, which is programmed to run that specific mode at that specific time.

The Mastertude Educational Game Modes

Certain preferred embodiments of the educational game module 165 teach the user/s music and/or any other educational topic and/or game and/or skill and/or knowledge in any subject.

In these preferred embodiments, the teaching interface 160 displays 3D/2D visual data, VR/MR/AR data on the individualized screen 142a of the output device 142 of each user/s, and commands the haptic and sensor output devices 143 to activate and deactivate in coordination with the timeline 110, 161.

In certain embodiments, within a cinema 200 of FIG. 5 or any large room, there are thousands of users and each one has their own individual frequency channel, login and password 162, which they utilize to receive individualized data from the educational game module 165 during the active mode 130. Each user activates a channel via a login with a unique number. This number is provided to them by the cinema or, for the home user, at the time of purchase or acquisition of a Mastertude film/system 100.

In preferred embodiments, the teaching interface 160 receives data from the educational game module 165, which interacts with the assessment compilation module 176, the assessment module 170 and the predetermined timeline 110. This process sends each user individualized data signals from the educational game module 165 to their output devices 142, 143 based on the feedback of their performance—received from the assessment module 170—and compiled by the assessment compilation module 176 in tandem with the time allotment from the predetermined timeline 110. This process serves to create a unique experience 163 for each user/s during the active mode 130. For example, certain embodiments of the teaching interface 160 sends individualized data/lessons for each user/s 163, which is constructed in the education game module 165 and comprises the teaching module 165a, the personalized module 165b and sub-module 165c. The data is chosen according to feedback received from the assessment module 170 and assessment compilation module 176 in accordance with the predetermined timeline 110.

The educational game module 165 in preferred embodiments is filled with multiple visuals, video-clips, audio-clips, animations, data and images. In certain embodiments, the educational game module 165 comprises a teaching module 165a, a personalized module 165b and a sub-module 165c. All three modules work together and integrate in order to send custom-made data/lessons to the teaching interface 160, which then sends said custom-made data/lessons to each user, based on their performance and preference 163.

The teaching module 165a of the educational game module 165 comprises lessons and predetermined instructions of many levels. It includes each educational topic and/or game and/or skill and/or knowledge in any subject in various levels, complexities, styles and variations. For example, for the keyboard music system, the education gaming module 165 stores five levels of each music topic under the levels marked in the following categories: below average, average, above average, advanced and non-engaged. Based on the performance level of the user, each user gains customized lessons 163 from the educational game module 165.

The personalized module 165b of the educational game module 165 in preferred embodiments is inputted by the cinema staff against seat numbers when tickets are booked and/or by the user. The information in the personalized module 165b includes, but is not limited to, the name, age, gender, color preference, music preference, contact details, complied feedback and other such information. The personalized module 165b stores a summary of each user/s performance, which is held in the assessment compilation module 176. The feedback is stored in a simple, clear way, such that improvements to the user/s' performance are immediately visible. For example, in the music interactive game, the feedback is compiled and stored under different headers such as (but not limited to) technicality, musicality, song repertoire, sight reading, theory, performance flair, etc. allowing the user/s to know their strengths and weaknesses within each area of the game. At the end of a performance, feedback could be sent by the personalized module to the user that summarizes the performance, allowing each user to monitor improvements, to compare themselves to the expected standards of that level, and to set goals for subsequent practices.

The lessons from the educational module 165 and teaching module 165a in preferred embodiments could also include personal, vocal or written comments and feedback from the personalized module 165b. For example, when learning a song, the level of the song is selected based on the compiled performance of the user. The tempo, style and genre of the song and any other preference are selected either by the user or created by automatic selection based on the age-group, gender, ethnicity and other such information of the user.

The personalized module 165b in certain embodiments also stores a number of responses, both audio and visual, of encouragement and other such feedback, as well as images and animations to indicate the different emotions, encouragement and other such feedback that it sends to the user/s as and when required.

The sub-module 165c of certain embodiments of the educational game module 165 includes the wide spectrum sub-module and the entertainment sub-module. The wide spectrum sub-module includes a wide spectrum of related topics for a specified subject matter. For example, (but not limited to) while learning a topic of music, the wide spectrum sub-module may include one or more related subject matters such as the mechanics and invention of the music keyboard, the physics and architecture of sound, the tones of the planets and so forth. By the implementation of the wide spectrum sub-module, the one or more users can understand and explore all aspects of the subject matter and gain a holistic, practical and meaningful understanding of the topic. The recreational sub-module includes one or more fun facts and/or topics. For example (but not limited to) the exploration of other realms within the narrative, which may or may not be related to the subject matter being studied.

In certain embodiments, each user/s can create their own, subjective reality within a virtual, augmented or mixed reality world or during the active mode 130. As they participate in learning the skillset, they view individualized realities on their screens 142a that is provided by the teaching interface 160. The output devices' 142, 143 data responses from the user/s are evaluated by the assessment module 170 and compiled by the assessment compilation module 176 in coordination with the predetermined timeline 110, after which specially constructed data is sent to the teaching interface 160 from the educational game module 165. A virtual agent may be included in order to give further instructions. The virtual agent could address one or more users by name and provide the user with a set of instructions, received from the personalization module 165b. For example, if musical scales are being taught and, after a few attempts, the user is not able to play that scale, the assessment module 170 tells the educational game module 165 to send a virtual agent over to that user's keyboard in their individualized virtual or augmented reality. The virtual agent could be the music-professor from the film narrative and/or one or more characters from the film narrative who will address the user by name and instruct them or demonstrate how to play the scale. The rest of the users will carry on playing the scale in their realities, with or without the virtual professors' help, as is necessary.

In certain embodiments, personalized questions may be given to each user via their headmount 142, based on his/her individual assessment data from the assessment module 170. Subsequently, the learning process is fine-tuned to ensure that each user gains maximum benefit.

In certain embodiments, the teaching interface 160 sends the initial lesson data in active mode generically for all levels of users from the teaching module 165a. It could be personalized, based on information from the personalized module 165b if required. Over time, as the user/s interact with the data from the teaching interface 160 using their output devices 142, 143, the assessment modules 170, 176 monitor their performance and, in coordination with the predetermined timeline 110, communicate with the educational game module 165 to send the user/s the next module and/or repeat the same module via the teaching interface 160.

For example, if the first lesson/data in the music teaching system is teaching diatonic chords of the D scale, then after this lesson data has been received by the user via the teaching interface 160 there may be 30 secs remaining as determined by the timeline 110 for this particular lesson/module. If one user plays the chords with five mistakes, it means that they have not mastered the topic, and, with only 30 seconds left, there is not enough time to reteach the topic. In this case, the assessment module 170, 176 communicates to the educational game module 165 to send that user some fun visuals from the submodule 165c of the educational game module 165. If another user has two mistakes in their performance and there are 30 secs as determined by the timeline 110, the assessment modules 170, 176 communicates to the teaching module 165a and personalized module 165b to send a virtual agent to correct the user's performance either by demonstration or instruction. If there is one mistake in the user's performance and there are 30 secs left, as determined by the timeline 110, the assessment modules 170, 176 communicates to the teaching module 165a to repeat the lesson. If there are no mistakes and the user completes the lesson quickly, so that there are 50 seconds left, as determined by the timeline 110, the assessment modules 170, 176 communicates to the teaching module 165a to send further, more complex information on this subject to the user via the teaching interface 160.

If there is a limited amount of time remaining, as determined by the timeline 110, and not enough time to repeat the module/lesson in its entirety, the submodule 165c and/or teaching module 165a and/or personalized module 165b sends another topic that can be completed in the prescribed time frame, so that there is no abrupt cut to the module when switching from the active mode 130 to the passive mode 120, or to the next teaching module/lesson within the active mode 130.

In certain embodiments the system/s 100 further comprises a server that has at least one personal interaction module for facilitating participation of a real teacher and/or a supervisor who could modify the lessons within the teaching module 165a of the educational game module 165 and/or change the timeline 110 and/or communicate to the user/s if and when required.

In certain embodiments, the teaching interface 160 and/or the educational game module 165 could send personalized, encouraging messages to one or more users, spoken through a virtual agent, and/or a live teacher or in text format through the individualized screen 142a, or in vocal format through the headphones 142c of the user.

In certain embodiments, the teaching interface 160, educational game module 165, predetermined timeline 110 and assessment module 170 and assessment compilation module 176 can be integrated or further separated and/or databases to store information could be added within the computerized system 100, based on the requirements of the educational topic and/or game and/or skill and/or knowledge in any subject being taught. The module/s and/or database/s and/or interface/s and/or timeline/s and/or other system/s and/or server/s can be integrated or further separated into additional modules and/or databases and/or interface/s and/or consoles and/or timeline/s and/or component/s and/or system/s and/or server/s and/or take any other form that allows them to communicate with each other and perform the function/s required. For example, the haptic feedback could send signals to a haptic feedback component and/or module that is separate from the sensor feedback module.

The Mastertude Assessment Modules

The computerized system 100 in preferred embodiments is embedded within an assessment module 170 that receives feedback from the output devices 142, 143 of each user/s and assesses the user/s' performance against predetermined parameters sent to the assessment module 170 from the teaching interface 160 and educational game module 165.

The assessment module 170 in certain preferred embodiments receives feedback from one or more output devices 143 embedded with sensors, sonic, midi, haptic or other technology. The output device 143 could be a glove, suit, footwear, keyboard, mouse, joystick, touch screen, graphic tablet and the like, or audio-visual devices 142 such as camera, microphone and the like, or a combination thereof.

The assessment compilation module 176 in preferred embodiments compiles the assessment feedback received from the assessment module 170 and sends this data to the educational game module. The compiled data of the user/s performance is stored in the personalized module of the educational game module. The assessment compilation module, along with the educational game module 165, in these embodiments performs the functions of a gaming console that allows the user to progress in their VR/AR or MR game when they reach a particular level of performance, or when the predetermined timeline 110 requires the user/s to move forward.

In certain embodiments, each in a cinema, this computerized system 100 communicates with thousands of VR/AR or MR headmounts 142 and thousands of output devices 143 (such as gloves and/or footwear and/or suits fitted with sensors and/or sonic and/or haptic technology) simultaneously. This assessment module 170 assesses each user individually and then gives them feedback. The system also allows the user/s to create their own reality and to progress in a similar manner to that of a game. For example, as shown in FIG. 5, a multiplayer assessment module 170 for a cinema auditorium 200 could include: (at least) thousands of output devices such as VR/AR/MR headmounts 142 and thousands of sensor, sonic, midi, and haptic output devices 143 such as gloves, suits, footwear and other such hardware devices. In particular, for certain embodiments, the visuals of the one or more teaching modules 165a of the educational game module 165 are displayed on individualized display screens 142a and the audio content is played through headphones 142b. The one or more users will interact with the VR/AR or MR through output devices 143, 142c embedded with sonic, haptic, midi and sensor technology. These would be located within the cinema auditorium 200, connected through a wireless network 180 to the master computerized system 100. The data recorded from the output devices 142, 143 by the one or more sensors and/or haptic and/or sonic and/or midi and/or other technology is communicated to the assessment module 170 on the user/s' individual channel frequency.

In certain preferred embodiments, the assessment module 170 is constantly evaluating the user against the parameters stored in the teaching module 165a of the educational game module 165. It determines if one or more users are making any mistakes and communicates data to the educational game module 165. The teaching interface 160 will send the user/s a repeat of the same subject matter at a slower pace either once or numerous times, or accelerate the pace, or teach further subject-matter, based on the user/s performance, within the predetermined timeline 110. In certain embodiments, even if the user hasn't fully accomplished the learning according to feedback received from the assessment module 170 and the time pre-allotted for that particular lesson has run out, the educational game module 165 allows the user to move forward as predetermined by the timeline 110, either onto the next lesson if the mode is still that of active participation 130, or onto the narrative if the mode is switching to that of passive mode 120.

In preferred embodiments, output devices 143 (with or without gloves) embedded with haptic, sonic or sensor technology, and output devices such as headmounts 142 allow each individual user to play the virtual key-based musical instrument, sending digital feedback to the assessment module 170. This assessment module 170 receives feedback from one or more—or even up to thousands—of gloves simultaneously, and/or one or more—or even up to thousands—of microphones 142c simultaneously for vocal assessment; assessing the keyboard and vocal skills of each user. In other words, the one or more haptics and/or sensors on the gloves 143 that are worn by the user/s, send feedback to the assessment module 170 when the (virtual reality/augmented reality or mixed reality) key or keys are pressed by the user. For example: the data received by the assessment module 170 from one or more sensors and/or haptics may include information about which key has been played and pressed (pitch), time duration of the key being pressed (timing), the pressure being applied (dynamics), and the movement of the fingers of the one or more users. The data received by the assessment module 170 from audio feedback may include information about the pitch, quality and other parameters of the singing voice and/or audio data signals through vocal answers or vocal commands sent through the microphone 142b.

In certain preferred embodiments, the assessment module 170 and output devices 142, 143 will vary according to the subject being taught. In certain embodiments, the user/s' output devices 142, 143 are embedded with a movement sensor/sensors that generates an output signal upon the detection of movement from the user. It is also embedded with audio sensor/sensors for generating the output signal upon the detection of a vocalization of the user. It should be noted that, in addition to the virtual reality suit, external sensors, such as image scanners, may be employed to accomplish similar objectives. In the case of other musical instruments, the assessment module 170 will determine the pitch and timing of the instrument, the pitch and timing of the singing voice, vocal dynamics and posture in a similar way by using the appropriate output devices 142, 143. In additional preferred embodiments, for educational and/or entertainment packages, the correct answers (voice, movement, posture, score and other such parameters) will be assessed by the assessment module 170 against parameters in the educational game module 165, giving the user ongoing, real-time feedback about their progress.

In certain embodiments, the data recorded by the assessment module 170 of each user is communicated to the assessment compilation module 176 and the educational game module 165 on each user/s' individual channel frequency. Consequently, the assessment module 170 and the assessment compilation module 176 determine the proficiency of the user/s in the subject and/or subjects being taught. Each user's feedback is stored in the assessment database 175 during the interactive active mode 130. This is stored on a digital storage facility and can be accessed by the user from any computer or system. Once they input their login name, email, ticket number, and cinema seat number or any other details that are required by the software, they gain access to the educational game and their previous achievements and interactions.

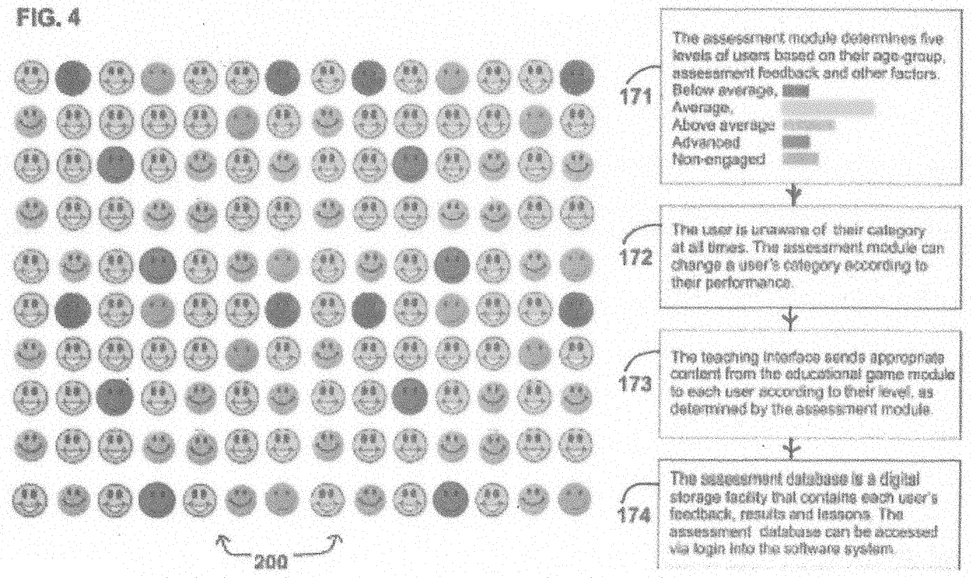

In preferred embodiments, the assessment module 170, along with assessment compilation module 176 and the educational module 165, determine the level of complexity, environment and other parameters for each user. Based on this assessment, individualized data and content are sent to each user. For example, for the music teaching system within a cinema or during a group experience within any room as in FIG. 4, the assessment module 170 sends data to the assessment compilation module, which compiles the feedback and, along with the educational game module 165, determines five levels of users: such as, below average, average, above average, advanced and non-engaged 171. The levels are determined from on the user/s' assessment feedback and/or age-group and/or other factors. During the active mode 130 within the cinema 200, or in any room, each user is sent content specifically designed for their level of competency. The user/s are unaware of their level at all times, particularly in a group-learning environment. The modules 165, 176 can change a user's level at any time according to their performance during the course of the active mode 130, 172. The teaching interface 160 sends appropriate content from the educational game module 165 to each user according to their level as determined by the assessment module 170, 173 in accordance with the timeline 110. After the group experience, the user can login to the assessment database 175 and access their unique feedback, lessons and results 174 by loading the software on their home system/computer/laptop/gaming consoles or any other such screen.

In certain embodiments, each user's unique feedback, lessons and results are stored in a digital storage facility called the assessment database 175. The assessment database 175 can be accessed via login. The feedback is stored and displayed in an easily understandable way, such that improvements to the user/s' performance are immediately visible.

In certain embodiments, the one or more educational game modules 165 and feedback from the assessment modules 170, 176 may be displayed on a television screen, a gaming console, a home computer monitor or hardware devices including, but not limited to, musical instruments fitted with sensors and the like. The display screen may be provided to the one or more users individually.

In certain embodiments, the assessment modules 170, 176 and educational game module 165 may include a component where the one or more users have to press at least one or many VR/AR or MR buttons or use one or more vocal commands that correspond to one or more options available. For example, the options may correspond to option “YES” or “NO”, or, where the one or more users have to answer a multiple choice question, the options may correspond to multiple options, for example, “a” or “b” or “c” or “d”.

Additional Mastertude Active Modes

In additional active mode 130 embodiments, through the viewing of the common screen 150, the system may include outputting an image or images that are superimposed on the film and/or the display screen. The user/s may thereby enjoy an AR or VR or MR experience through their individualized screen 142a, in addition to the visuals on the home screen, cinema screen or common display screen 150. For example, a person with an AR/VR/MR output device may see a character from the film walk out of the screen 150, or a keyboard pops up in front of each user in the room or cinema 200.

Also, during the film in the cinema 200 or any other room or location, an AR object, for example, an AR keyboard, could be superimposed in front of the user/s through their individualized screen 142a. Or, alternatively, the user/s may be able to interact with objects depicted in the AR, MR or VR output using their output devices 142, 143.

In certain preferred embodiments, a change made or feedback received by the user/s' output devices 142, 143 could change the output on the common display screen 150 for all users in the cinema 150.

In certain embodiments, the different versions of audio-visuals may be stored in a cinema database and/or educational game module 165. The assessment module 170 selects an image, or piece of audio or visual content, to be played on the common screen 150 or superimposed based on the overall feedback received from the output devices 142, 143 of all users, changing the group experience. In other words, based on the overall performance of the group, the assessment module 170 and assessment compilation module 176 sends data to the film module 230 about which version of the audio-visual data to play (from the cinema database) on the common display screen 150 and/or which audio-visual data to play on the headmount 142 (from the educational game module 165).

The Mastertude Haptic And Sensor Glove Output Devices

In preferred glove embodiments, the glove is fitted with haptic or other such technology. The glove comprises two, five-fingered data gloves that track finger positions and postures and use micro-speakers to create simulated vibrations and sounds. It enables tactile feedback, force feedback, and motion tracking. The user can learn musical instruments and other subjects of education using sensors and/or haptic feedback through the VR/AR and MR. The glove is fitted with sensors or other such technology and sends and receives feedback from the assessment module 170, educational game module 165 and teaching interface 160. This sensor or other such technology tests the user/s' performance and gives the user feedback and lessons.

The VR environment for each user may be different and changes based on the feedback received from the gloves. In certain preferred embodiments, a virtual agent can enter the user/s' experience via their individual screen 142. The virtual agent gets sent by the teaching interface 160 and is directed by the assessment module 170 and educational game module 165. The agent can interact with the user and help the user/s through both demonstration and instruction.

The Mastertude Headmount Output Devices

In preferred headmount embodiments, the headmount 142 is lightweight and comprises special glasses that can switch between 2D and 3D mode 120 to AR, VR and MR 130. This headmount 142 is controlled by the computerized system's software and is operated through wireless technology 180. The headmount 142, tethered or untethered, interacts with the computerized system 100 by sending and receiving feedback. The headmount's glasses switch between operating as an individualized screen 142a during the active modes and see-through lens 141 during the passive mode, in accordance with the timeline. The headmount 142 has high quality and surround sound headphones 142c, and a microphone 142b, which allow the user to hear their own voice and, when singing, to hear their voice on pitch, and also interact with the VR/AR or MR data. The user/s can also hear the surround sound speakers 210 of the cinema 200 or home studio through their headphones 142c when they are switched off or on reduced volume or/and hear the sound feedback through both the speakers 210 and headphones 142c. The headmount 142 has a high-quality microphone 142b for speaking and singing that feeds back to the user and sends signals to the assessment module 170. The headmount 142 is also outfitted with a camera 142d to allow for AR/VR/MR interaction and a wireless receiver 142e.

Other Haptic And Sensor Output Devices Used With Mastertude

In certain embodiments, output devices 143 such as a suit, footwear and socks and other devices are fitted with haptic or other such technology to track movement. The suit or socks use micro-speakers to create simulated vibrations and sounds. It enables tactile feedback, force feedback, and motion tracking. The user can learn musical instruments and other subjects of education using sensors and haptic feedback through the VR/AR and MR. The suit, socks or other such output devices can be fitted with sensors or other such technology to send and receive feedback from the assessment module 170, educational game module 165 and teaching interface 160, which test the user/s performance and then gives the user/s feedback and lessons.

### The Mastertude Computerized System

Preferred embodiments of the computerized system 100 comprise the following technologies, some or all of which can be integrated together in such embodiments of the computerized system 100:

1. Film Module: The computerized system 100 contains a film module that controls a system/systems and/or directly sends 3D/2D audio-video data signals based on a predetermined timeline 110 to a cinematic screen 150, home screen, individualized screen or any screen and surround sound system 210 using a projector 190 over a wireless network 180.
2. Educational game module 165: The computerized system/s 100 comprises a teaching module 165a, which comprises Teaching Visuals, Videos, Software, Animations and special Interactivity Technology. This module sends data to the output devices 142, 143 and the assessment module 170. Module 160 receives data from the assessment module 170 and the predetermined timeline 110. Based on the feedback received, it creates individualized (visual/audio/images/software/game/animation/video) data for each user.
3. Assessment module 170: The assessment module 170 constantly receives feedback from the sensors and/or haptics in the output devices 142, 143 of each user/s and/or assesses that feedback data against the data received from the educational game module 165. The assessment module 170, coupled with the assessment compilation module 176, interacts in real-time with the educational game module 165 to send customized feedback to each user, in accordance with the timeline 110. For example, whether to repeat the lesson or move on or any other such instructions.
4. Educational game module 165: The Educational game module of the computerized system 100 customizes the data sent by the teaching interface 160 to each user, based on their performance and/or preference. The teaching module 165a of the educational game module 165 is filled with different levels of lessons, options and versions of each visual/image/video/audio/game/animation and/or software data that educates and entertains based on the user/s preference and/or ability. The educational game module 165 also has a personalized module 165b that includes, but is not limited to, the personal information, feedback, test results, assessments and gaming preferences of each user. Module 165 also holds related and additional visuals/images/videos/audios/game/animations and/or software in a sub-module 165c that can be sent to the user as and when required.
5. Predetermined timeline 110: The predetermined timeline controls the switch between passive mode 120 and active mode 130. It communicates to the output devices 142, 143, system/s, software/s, module/s, server/s and/or other devices to switch on and switch off. The predetermined timeline 110 determines the time allotted for each mode and moves the system along. For example, in certain embodiments, if the entire film in the cinema (including the passive mode 120 and active modes 130) is three hours, the predetermined timeline doesn't allow the user/s to spend more or less time than the allotted time within each mode and/or session.
6. Additional modules and/or features can also be used, including such modules and/or features that perform additional functions, including such functions as described or otherwise identified above.

The Mastertude Feedback Stored For Users

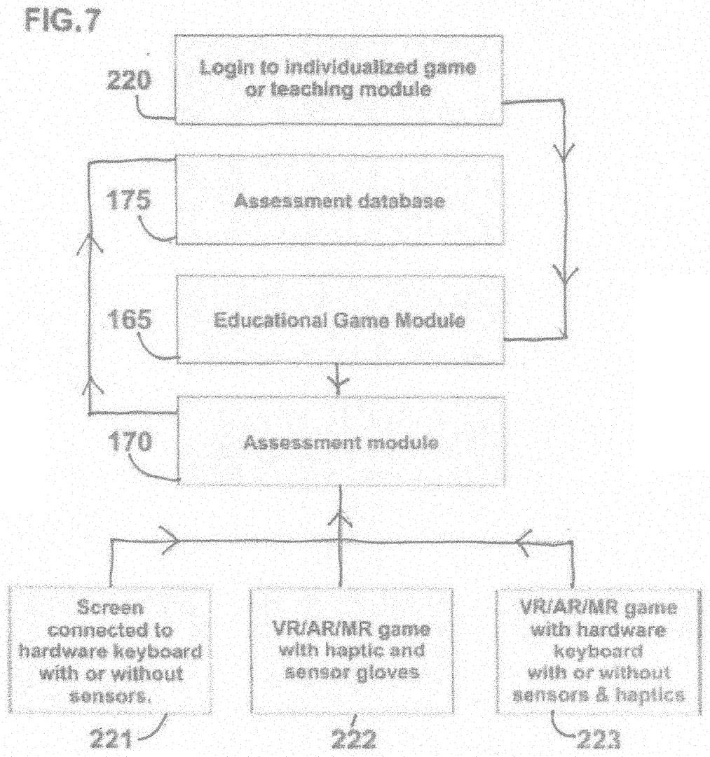

In certain preferred embodiments, as shown in FIG. 7, the user can access the film module 230, educational game module 165 and/or teaching interface 160 via subscription and login 220 and the uploading of the software 100 on their home system/computer/laptop/Gaming consoles or any such system. Once all these elements are in place, the user/s can access the Mastertude server/s or system/s at all times.

In certain embodiments, if the user/s have already got their login and password, they can access the assessment database 175, which is a digital storage facility that comprises their unique feedback, lessons and results. The user can continue from the level they were at previously.

In certain embodiments, if the user/s have already got their login and password, then every detail and/or specification from their last interaction is remembered and stored by the system/s personalized module 165b especially those saved by the user. For example, in the music learning system, the settings and/or data saved by the user on their VR/AR/MR keyboard using the recording facility/feature on the music-keyboard, such as selected tones, styles are stored in the banks, a complete and/or incomplete composition. In certain embodiments if the user wants to reboot their settings and/or delete saved data and/or begin the educational game again, this too is permitted by the system.

In certain embodiments, to participate in the active mode 130 and the teaching interface 160, the user/s can use hardware devices 221, 223 that are directly attached to the system 100 using midi or other such technology, or output devices 222 that are embedded with sensors or haptics. For example, for the Music learning system, the user can play a hardware keyboard embedded with sensors 221, a hardware keyboard connected to a home system via midi or other such technology 221, a VR keyboard through a VR headmount 222, 223, an AR keyboard via an AR headmount or a MR keyboard, which communicates with the home system 222 223. The assessment module 170 assesses the user/s' performance, through gloves with sensors 222, or a keyboard with sensors 221 223, or through a hardware keyboard that is plugged into the system 221 or via any other means that allow feedback to be sent to the assessment module 170. The assessment module assesses the feedback against the parameters in the educational game module 165, thereby continuously monitoring the user's performance and allowing them to achieve higher levels. The user/s can play individually or interact with other users online.

In certain embodiments, the user/s can contribute different data during the active mode 130 to an online group space and/or server/s that all user/s who are logged on, regardless of their geographical location, can access and interact with, while being assessed in real-time or not.

In certain embodiments, there are prescribed live streaming sessions that user/s can participate in at home or in another environment of their choice. This enables them to participate with other users online.

### OTHER EMBODIMENTS

Although the present invention has been described with reference to teaching, examples and preferred embodiments, one skilled in the art can easily ascertain its essential characteristics, and without departing from the spirit and scope thereof can make various changes and modifications of the invention to adapt it to various usages and conditions. Those skilled in the art will recognize or be able to ascertain using no more than routine experimentation, many equivalents to the specific embodiments of the invention described herein. Such equivalents are encompassed by the scope of the present invention.

What is claimed is:

1. A computerized educational and entertainment system for one or more users, the system comprising:
a. a film module comprising audio-video content;
b. one or more active modes comprising the computer executable functions of providing interactive teaching of subject matter to each of the one or more users;
c. an educational game module comprising the computer executable functions of providing input, feedback, instructions, interactions, and/or results from each of the one or more users to the system; and
d. wherein the audio-video content from the film module is played to the one or more users and interrupted by the one or more active modes at one or more set times to provide the interactive teaching of subject matter to each of the one or more users, and wherein each of the one or more users can provide input, feedback, instructions, interactions and/or results to the system.

2. The computerized educational and entertainment system of claim 1, wherein the audio-video content is in the form of a narrative film.

3. The computerized educational and entertainment system of claim 1, wherein the system resides on one or more servers that is accessed by the one or more users and each of the one or more users interacting with the interactive teaching using a headmount.

4. The computerized educational and entertainment system of claim 1, wherein the interactive teaching of subject matter is adjusted in difficulty level according to each of the one or more users' ability to respond to the interactive teaching of subject matter.

5. The computerized educational and entertainment system of claim 1, wherein the system is accessed over a wireless communication system.

6. A computerized educational and entertainment system for one or more users, the educational and entertainment system comprising:
a. a film module, the film module comprising audio-visual content to stimulate learning by the one or more users;
b. one or more predetermined timelines, the one or more predetermined timelines each executing a function that provides an educational game module instructions concerning the length of time given to each of four modes, the four modes comprising;
i. a passive mode, wherein during the passive mode the one or more users each view the audio-visual content in 3D/2D through one or more cinema/real environment devices, the one or more cinema/real environment devices are each selected from the group consisting of a common screen for multiple users, a personal screen, a headmount, other displays, computers, laptops, gaming consoles, tablets, watches, telephones, speakers, a camera, a microphone, a projector, other such presentation, viewing or audio-video devices, and/or combinations thereof;
ii. a first active mode, wherein during the first active mode the one or more users each (1) view the audio-visual content through a headmount and/or (2) interact with the audio-visual content through one or more output devices, the one or more output devices each selected from the group consisting of devices with haptic, sensor, sonic, midi, and/or magnetic tracking capability; personal audio-visual components; wearable devices with headmounts, gloves, footwear and/or suit hardware; keyboards, mouse, joystick, game controllers, touchscreen, graphic tablet; and devices that communicate digital data, including output device data pertaining to each of the one or more users;
iii. a second active mode, wherein during the second active mode the one or more users each (1) view the audio-visual content through the headmount, (2) interact with the audio-visual content through the one or more output devices, and/or (3) interact with the audio-visual content through the one or more cinema/real environment devices; and
iv. a combination mode, wherein during the combination mode two or more of the passive mode, the first active mode, and; or the second active mode operate simultaneously;
c. the educational game module, the educational game module comprising a teaching module, a personalized module and a submodule, the educational game module executing functions in accordance with the instructions from the one or more predetermined timelines, using teaching content, personal information, user feedback, user instruction and/or user interaction from the teaching module, the personalized module and the submodule;
d. the teaching module, the teaching module comprising the teaching content to be taught and/or provided to each of the one or more users;
e. the personalized module, the personalized module comprising the personal information for each of the one or more users and/or the user feedback for each of the one or more users; and
f. the submodule, the submodule performing functions comprising storing data that is required by the instruction and/or interaction from each of the one or more users.

7. The computerized educational and entertainment system of claim 6, wherein the audio-video content is in the form of a narrative film.

8. The computerized educational and entertainment system of claim 6, wherein the system resides on one or more servers.

9. The computerized educational and entertainment system of claim 6, wherein the interactive teaching of subject matter is adjusted in difficulty level according to each of the one or more users' ability to respond to the interactive teaching of subject matter.

10. The computerized educational and entertainment system of claim 6, wherein the system is accessed over a wireless communication system.

11. A computerized educational and entertainment system for one or more users that each provide input, feedback, instructions, interactions and/or results to the educational and entertainment system, the educational and entertainment system comprising:
a. a film module, the film module comprising audio-visual content to stimulate learning by the one or more users;
b. a teaching interface, the teaching interface comprising an interactive interface that provides i. virtual reality, ii. augmented reality, iii. mixed reality, or iv. a combination of two or more of i. ii., or iii., instructions and content to one or more output devices, the one or more output devices each selected from the group consisting of devices with haptic, sensor, sonic, midi, and/or magnetic tracking capability; personal audio-visual components; wearable devices with headmounts, gloves, footwear and/or suit hardware, keyboards, mouse, joystick, game controllers, touchscreen, graphic tablet; and devices that communicate digital data, including output device data pertaining to each of the one or more users;
c. one or more predetermined timelines, the one or more predetermined timelines each executing a function that provides an educational game module instructions concerning the length of time given to each of four modes, the four modes comprising;
i. a passive mode, wherein during the passive mode the one or more users each view the audio-visual content through one or more cinema/real environment devices, the one or more cinema/real environment devices are each selected from the group consisting of a common screen for multiple users, a personal screen, a headmount, other displays, computers, laptops, gaming consoles, tablets, watches, telephones, speakers, a camera, a microphone, a projector, other such presentation, viewing or audio-video devices, and/or combinations thereof;
ii. a first active mode, wherein during the first active mode the one or more users each (1) view the audio-visual content through a headmount and/or (2) interact with the audio-visual content through the one or more output devices;
iii. a second active mode, wherein during the second active mode the one or more users each (1) view the audio-visual content through the headmount, (2) interact with the audio-visual content through the one or more output devices, and/or (3) interact with the audio-visual content through one or more of the cinema/real environment devices; and
iv. a combination mode, wherein during the combination mode two or more of the passive mode, the first active mode, and/or the second active mode operate simultaneously;
d. an assessment module, the assessment module executing functions comprising i. receiving data from each of the one or more output devices, ii. assessing the data against predetermined parameters in real time, and iii. providing feedback data to an assessment compilation module;
e. the assessment compilation module, the assessment compilation module executing functions comprising compiling of feedback data from the assessment module and each of the one or more output devices in the form of the output device data and sending the feedback data and the output device data to an educational game module;
f. the educational game module, the educational game module comprising a teaching module, a personalized module and a submodule, the educational game module executing functions in accordance with the instructions from the one or more predetermined timelines, using teaching content, personal information, user feedback, user instruction and/or user interaction from the teaching module, the personalized module, the submodule and/or the assessment compilation module;
g. the teaching module, the teaching module comprising the teaching content to be taught and/or provided to each of the one or more users;
h. the personalized module, the personalized module comprising the personal information for each of the one or more users and/or the user feedback for each of the one or more users; and
i. the submodule, the submodule performing functions comprising storing data that is required by the instruction and/or interaction from each of the one or more users.
j. an assessment database, the assessment database comprising a digital storage facility that stores input, feedback, instructions, interactions and/or results from each of the one or more users;
k. the one or more output devices;
l. the one or more cinema/real environment devices; and
m. hardware to access a wired or wireless communication network.

12. The computerized educational and entertainment system of claim 11, Wherein the audio-video content is in the form of a narrative film.

13. The computerized educational and entertainment system of claim 11, wherein the system resides on one or more servers that is accessed by the one or more users.

14. The computerized educational and entertainment system of claim 11, wherein the interactive teaching of subject matter is adjusted in difficulty level according to each of the one or more users' ability to respond to the interactive teaching of subject matter.

15. The computerized educational and entertainment system of claim 11, wherein the system is accessed over a wireless communication system.

16. The computerized educational and entertainment system of claim 11, wherein the visual mechanism on the lenses and/or glasses and/or screens and/or panels of the headmount are fitted with sensors and/or send/receive a digital signal from the computerized system and/or timeline and/or server to switch into one of the four modes and/or switch from see-through to opaque and/or open and shut a visor and/or shutter screen.

17. A method of teaching subject matter to one or more users, the method comprising:
a. providing a film comprising audio-video content to the one or more users using a computerized educational and entertainment system, the computerized educational and entertainment system comprising one or more modules and one or more computer executable functions;
b. interrupting the film one or more set times, each time with one or more active modes using the computerized educational and entertainment system and computer executable functions of providing interactive teaching of subject matter to each of the one or more users; and
c. providing input, feedback, instructions, interactions, and/or results from each of the one or more users to the computerized educational and entertainment system using an educational game module.

18. The method of claim 17, wherein the audio-video content is in the form of a narrative film.

19. The method of claim 17, wherein the computerized educational and entertainment system resides on one or more servers that is accessed by the one or more users.

20. The method of claim 17, wherein the interactive teaching of subject matter is adjusted in difficulty level according to each of the one or more users' ability to respond to the interactive teaching of subject matter.

21. The method of claim 17, wherein the system is accessed over a wireless communication system.
